(19) United States
(12) Patent Application Publication
(10) Pub. No.: US 2026/0288496 A1
(43) Pub. Date: Sep. 24, 2026

(54) HUMAN-AI CO-CREATION SYSTEM

(71) Applicant: Articul8 AI, Inc., Santa Clara, CA (US)

(72) Inventors: Arun Karthi Subramaniyan, Santa Clara, CA (US); Gautam Subbarao, Santa Clara, CA (US); Vidya Govindan, Santa Clara, CA (US); Parvathi Letha, Santa Clara, CA (US)

(21) Appl. No.: 19/644,973

(22) Filed: Apr. 10, 2026

Related U.S. Application Data
(63) Continuation of application No. 19/383,537, filed on Nov. 7, 2025.
(60) Provisional application No. 63/718,401, filed on Nov. 8, 2024.

(51) Int. Cl. G06F 9/451; G06F 3/0484; G06F 8/30; G06F 8/33; G06F 8/35; G06F 8/71; G06N 5/043; G06V 30/422

(52) U.S. Cl. CPC G06F 9/451; G06F 3/0484; G06F 8/35; G06F 8/71; G06N 5/043; G06F 8/30; G06F 8/33; G06V 30/422

(57) ABSTRACT

Provided is a process including: obtaining an objective for a multi-agent artificial intelligence (AI) platform to generate a software application; determining a domain to which the objective applies; accessing information in the domain; using the information in the domain, with a reasoning AI model, decomposing the objective into sub-objectives to complete the objective; determining with the AI platform, user interface (UI) components of the software application; orchestrating a plurality of AI agents of the AI platform to determine how to configure at least some of the UI components and how to respond to input from at least some of the UI components; and storing a first version of the software application in memory.

### CROSS-REFERENCE TO RELATED APPLICATIONS

This application is a continuation of U.S. patent application Ser. No. 19/383,537, filed Nov. 7, 2025, titled HUMAN-AI CO-CREATION SYSTEM which claims benefit of U.S. Provisional Patent Application 63/718,401, filed Nov. 8, 2024, titled IMMERSIVE HUMAN-AI CO-CREATION INTERFACE. The entire content of each afore-listed earlier-filed application is hereby incorporated by reference for all purposes.

### BACKGROUND

### 1. Field

The present disclosure relates generally to artificial intelligence (AI) and, more specifically, to use of multi AI agent systems to create highly customized special purpose software applications.

### 2. Description of the Related Art

In many organizations, building enterprise software applications involves gathering requirements, designing user experiences, implementing data flows, and connecting a mix of services and systems. Teams iterate on features, review compliance and security considerations, and deploy updates across environments while coordinating among product, engineering, and operations. This work often spans documents, dashboards, and integrations that should be generally understandable to stakeholders and maintainable over time.

Low-and no-code tools can speed up parts of this process, but they may limit how interfaces adapt to complex data, how logic scales across use cases, or how teams track what happens inside a workflow. In some settings, these tools make it hard to blend domain-specific analysis with clear explanations and audit trails, or to evolve an application while preserving user context. As a result, certain organizations seek approaches that keep speed while improving transparency, flexibility, and fit for enterprise environments.

### SUMMARY

The following is a non-exhaustive listing of some aspects of the present techniques. These and other aspects are described in the following disclosure.

Some aspects include a process including: obtaining an objective for a multi-agent artificial intelligence (AI) platform to generate a software application; determining a domain to which the objective applies; accessing information in the domain; using the information in the domain, with a reasoning AI model, decomposing the objective into sub-objectives to complete the objective; determining with the AI platform, user interface (UI) components of the software application; orchestrating a plurality of AI agents of the AI platform to determine how to configure at least some of the UI components and how to respond to input from at least some of the UI components; and storing a first version of the software application in memory.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a block diagram of an example computing environment in which the present techniques may be implemented.

FIG. 2 is an example process by which the present techniques may be implemented.

FIGS. 4A-F illustrate a user interface of a compliance application generated with the techniques of FIGS. 1 and 2.

FIGS. 5A-B illustrate a user interface of an engineering diagram analysis suite software application generated with the techniques of FIGS. 1 and 2.

FIGS. 6A-B illustrate a user interface of a code generation assistant generated with the techniques of FIGS. 1 and 2.

FIGS. 7A-E illustrate a user interface of a network data analyzer software application generated with the techniques of FIGS. 1 and 2.

FIGS. 8A-F illustrate a user interface of a data analysis application generated with the techniques of FIGS. 1 and 2.

FIG. 9 illustrates a dashboard of an application development system like that of FIGS. 1 and 2.

FIG. 10 is an example of a computing device by which the aforementioned computing environments and processes may be implemented.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the fields of AI and human computer interaction (HCI). Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Certain embodiments may include a UI planner agent integrated within a multi-agent system that receives a natural-language mission, determines a domain, and decomposes the mission into sub-missions that an application can execute. The UI planner agent may determine that a compliance use case calls for uploading policy documents, extracting rules from text and images, applying those rules to evaluation documents, and causing views that associate extracted rules with evaluation outcomes. The UI planner agent may select data sources and tools, determine sequencing, and specify how outputs feed user-visible components and background processes.

The UI planner agent may determine which UI components to present and how to arrange them. The agent may select uploaders, image galleries, buttons, charts, text inputs, and other widgets, determine interaction logic, and issue instructions by which a UI agent renders those components. Layout decisions may account for screen size and available space so components resize or relocate as conditions change. Event handlers may be generated so the application can obtain inputs, access analysis results, and cause updates without manual rewiring.

An autonomous orchestrator may coordinate communication and task distribution across a large pool of agents. Domain-specific agents may contribute sector knowledge such as energy, semiconductor, finance, or engineering practices, while task-specific agents may perform focused operations such as rules extraction, data queries, validations, image analysis, or calculations. The orchestrator may manage execution order, error recovery, and retries, obtain intermediate results, and return outputs to the UI agent so the application remains responsive as processing progresses.

The system may support real-time change during use. A user may request a layout change or a workflow adjustment, and the platform may obtain this feedback, determine modifications, and update components or logic, in some embodiments while preserving session state. In this way, the application may evolve as users interact with it, with the UI planner agent and the orchestrator causing the necessary updates to design, code, and data flow so that the application continues to operate while adapting to user needs.

Certain embodiments may receive a natural-language objective and cause a multi-agent platform to generate a working application from that objective. A reasoning model may determine a domain, decompose the objective (such as a mission) into sub-objectives, and select data sources and tools. A UI planner may determine interface components and a layout, while code generation agents may produce event handlers and rendering code. A coordinator module may select task-specific and domain-specific agents to supply analysis and data to each component, and may update the running application as feedback arrives. In some cases, the platform may change a first version into a second version during a user session while preserving session state.

Some embodiments may mitigate gaps found in low or no code tools by accessing data at the time of ingestion and recording what was received, how it was processed, and which resources were used. The system may analyze tables and images, extract facts, and create or update a knowledge graph. A processing view may present a flow that shows each step, its inputs, and its outputs, with citations available in a side panel. A question view may allow a user to pose questions to multiple language models, determine relevance scores for each response, and provide a consolidated answer, while allowing the user to fork questions and track how results change across branches.

Some embodiments may provide hyper-personalized applications that address enterprise tasks. Examples that may be generated include a compliance analysis application that may obtain a policy document, extract rules from text and images, evaluate another document against those rules, and cause a visualization that associates content with pass or fail determinations. In another example, an engineering application may ingest a design document, detect a single-line diagram or other diagram, determine components, and present an inventory. An example generated network application may ingest a configuration file, determine a topology, and cause a graph that reflects devices and links. Additional applications may provide clustering, time-series views, and supply-chain summaries, using charts such as force-directed graphs, clustered graphs, chord diagrams, and time-series plots that the UI planner selects and sizes based on client screen dimensions.

Further embodiments may support an application library to speed creation and reuse. A user may request a mission, and the platform may determine which agents to call, obtain outputs, and bind those outputs to UI components so interactions remain consistent across the application. Tenant administration may allow an enterprise to manage users, groups, access to websites and data, and deployment within a private network.

In some embodiments, the present techniques may be integrated with systems and processes described in other patent applications by the applicant filed on the same day as this filing. Some embodiments may apply personas to shape model outputs with the techniques described in the US patent application bearing attorney docket number 078474-0586614, titled CREATING CONTEXT-SPECIFIC, VERSATILE EXPERT AI PERSONAS. Some embodiments may render model outputs explainable with the techniques described in the US patent application bearing attorney docket number 078474-0586619, titled ROBUST EXPLAINABLE ARTIFICIAL INTELLIGENCE. The entire content of each afore-mentioned patent filing in this paragraph is hereby incorporated by reference.

Certain embodiments of as computing environment 10 may include an application development system 12 that receives objectives and causes applications to be generated and updated. An AI platform 14 may supply reasoning, planning, and tool use for those operations and may reside within the application development system 12 or operate as an independent service. An enterprise data repository 15 may store documents, databases, and other records of an enterprise that may be non-public and domain specific. User devices 16 may provide requests, supply feedback, and display results produced by the application development system 12 and the AI platform 14.

The computing environment 10 may operate entirely within an enterprise network, span a mix of on-premises and cloud segments, or be fully public. Network 18 may be private and secured through identity controls, network segmentation, private routing, and encrypted transport or may be (or may include) the public Internet. The application development system 12 and the AI platform 14 may access non-public sources inside the enterprise while honoring data residency, access policies, and audit requirements. In some deployments, components may reside on dedicated subnets and use private endpoints or peering links so traffic does not traverse the public internet. The system may determine where to execute processing based on policy and may cause records of access and lineage to be written for later review.

Multi-tenant versions of the AI platform 14 or the application development system 12 may serve more than one business unit or customer while maintaining isolation. The platform may obtain requests from different tenants, determine tenant context, and enforce data and model separation at runtime. Administrative functions may allow a tenant to manage users, groups, and integrations without exposing resources of other tenants. In hybrid deployments, some tenants may keep sensitive workloads inside the enterprise network while other tenants access hosted services, with controls that limit cross-tenant movement of data and models.

The data repository 15 may store any or all of a broad range of files, data structures, and records maintained by an organization. The repository may obtain and retain databases that hold transactional records and reference tables, knowledge bases that capture curated facts and relationships, wikis that record policies and procedures, and document repositories that store contracts, reports, and multimedia. The repository may keep logs, configuration files, spreadsheets, presentations, emails, images, diagrams, and time-series feeds. In some cases, the repository may include graph stores that represent entities and links, columnar stores for analytics, and object stores for large binaries. The system may access these sources through connectors or APIs and may resolve permissions based on enterprise policy.

A financial institution may keep account ledgers, wire instructions, exception files, scanned checks, KYC (know your customer) profiles, loan packages, pricing models, and audit reports. A healthcare facility may store electronic health records, lab results, imaging studies, discharge notes, and payer guidelines, while a clinical trial provider may keep protocols, informed consent forms, site reports, adverse event reports, sensor streams, and de-identified datasets. A research institution or university may store grant applications, IRB (institutional review board) approvals, course materials, publications, laboratory notebooks, microscopy images, sequencing results, and data management plans. A manufacturer may retain bills of materials, CAD (computer aided drafting) drawings, single-line diagrams, work orders, quality checks, machine telemetry, maintenance logs, and supplier certifications. A media company may keep editorial calendars, scripts, video masters, audio stems, caption files, image libraries, ad copy, rights metadata, and content performance summaries.

The repository 15 may hold both public and non-public materials and may reflect the specific domain of the enterprise. Records may appear as relational tables, JSON (Javascript™ object notation) documents, XML (extensible markup language) files, PDFs (printable document format), images, or proprietary formats, and the system may determine how to parse and index them so downstream components can retrieve, analyze, and present them. In some deployments, the data repository 15 may keep lineage and access metadata so later processes can determine provenance, apply retention rules, and cause appropriate safeguards when content is retrieved or moved between environments.

During operation, user devices 16 may communicate over a network 18 that may be the public internet or a private enterprise network. The application development system 12 may obtain content from the enterprise data repository 15, access the AI platform 14 for analysis and generation, and cause user interfaces to be delivered to user devices 16. In some cases, the system may determine where to execute processing based on policy or access constraints and may maintain session state so changes appear without interrupting ongoing use.

In some embodiments, a user device 16 may be a general-purpose computing platform that may run an operating system such as Windows™, macOS™, Linux™, iOS™, or Android™ and may execute a client application that may prepare, transmit, and receive serialized request and response messages destined for an AI platform 14 over the internet 18. The client application (e.g., a browser or a native application) on the user device 16 may accept user input, may normalize text using configured tokenization and Unicode normalization, and may assemble a request object that may include a prompt string, model selection hints, client-side timestamps, and an idempotency key. The user device 16 may open a Transport Layer Security session to the AI platform 14 via the internet 18, may attach authentication material such as bearer tokens or mutual Transport Layer Security client certificates, and may send the request over Hypertext Transfer Protocol. The user device 16 may maintain a queue for pending requests and may implement an asynchronous loop that may dequeue the next request, check network status, sign a payload using a device key stored in a secure element such as Secure Enclave™ or Android™ Keystore, transmit the payload to the AI platform 14, and store a response in non-volatile storage on success. On retryable errors, the loop may increment an attempt counter, requeue the request, and back off using a randomized delay. The user device 16 may, in some embodiments, cache context artifacts and evaluation datasets subject to a least-recently-used eviction policy and may record a provenance record containing request identifiers, hash digests of payload fragments, and server-supplied audit metadata associated with responses received from the AI platform 14.

In some embodiments, multiple user devices 16 (e.g., more than 10, more than 100, or more than 10,000) may operate within an enterprise deployment and may be geographically remote across regions while accessing the AI platform 14 through the internet 18. Each user device 16 may register with an identity provider, may fetch configuration profiles from a device management service, and may synchronize policy that may specify permitted endpoints reachable over the internet 18, storage encryption requirements, and certificate pin sets for connections to the AI platform 14. A user device 16 may select among service endpoints of the AI platform 14 by issuing health probes, measuring round-trip time, and choosing a preferred endpoint for a session while maintaining a fallback list. The user device 16 may compress payloads using a streaming compressor and may segment large uploads into fixed-size chunks that may be reassembled server-side using chunk indices and a session identifier. Administrative controls for the user devices 16 may include a signed command channel that may trigger policy refresh, cache invalidation, or client updates. The client application on a user device 16 may verify command signatures against a pinned public key and may reject out-of-order commands based on monotonically increasing sequence numbers. User devices 16 may be used to request the generation of, provide feedback to edit, and to use software applications automatically (e.g., with no or limited human intervention) generated with the system 12.

Certain embodiments may include an application development system 12 that coordinates generation and evolution of applications from natural-language objectives. A controller 20 may obtain a mission, determine context, and cause other subcomponents to perform analysis and synthesis in a (pre-defined or dynamically determined) sequence. Document ingest 22 may access enterprise sources, receive files, and extract text, tables, and images while recording provenance so later steps can determine what was processed and when. A UI planner 24 may interpret tasks, decompose them into sub-missions, determine user interface components, and select a layout that adapts to client constraints and data needs.

A UI generator 26 may obtain plans from the UI planner 24 and cause executable code, event handlers, and bindings to be produced so components render and interact. Domain specific agents 28 may supply sector knowledge for areas such as finance, energy, or engineering, and task specific agents 30 may perform focused operations such as rule extraction, validation, image analysis, search, or calculations. The controller 20 may determine which agents to invoke, obtain intermediate outputs, and pass results to the UI generator 26, so the interface reflects current analysis.

A runtime 32 may execute the resulting generated application, manage sessions, and access data and models according to policy. During operation, the runtime 32 may receive inputs from user devices 16 and from the enterprise data repositor 15, obtain services from agents of platform 14, and cause updates to views and workflow state. A feedback module 34 may collect user comments and telemetry, determine requested modifications, and return those to the controller 20 so components, layouts, and logic can change while preserving session context.

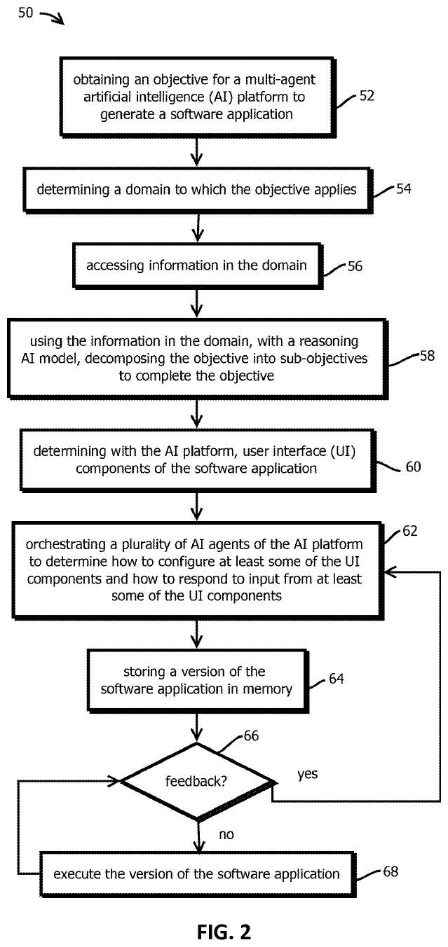

In some deployments, the controller 20 may execute a process described with reference to FIG. 2 to coordinate these subcomponents. The controller 20 may determine ordering, handle errors and retries, and cause re-planning when objectives change. By obtaining missions, accessing content, determining layouts, invoking agents, and updating generated code through the runtime 32 and feedback module 34, the application development system 12 may provide adaptation from intake through delivery and use.

Document ingest 22 may receive human-readable and machine-readable materials and cause them to be parsed into structured or semi-structured (e.g., structured data containing unstructured content in fields) outputs. The module may obtain files from the enterprise data repository 15 and user devices 16, including PDFs, word processing files, spreadsheets, emails, images, scanned forms, database query results, and wiki pages. For unstructured text, the module may apply language models to segment sections, determine headings, extract lists and tables, and identify relationships stated in natural language. For scanned or image-only sources, the module may apply optical character recognition to recover text and layout, and may preserve page, paragraph, and coordinate references so later stages can locate cited content. The module may normalize encodings, remove artifacts, and record provenance so downstream components can determine when and how a given record was created.

The module 22 may apply named-entity extraction to determine people, organizations, devices, materials, locations, dates, amounts, and citations, and may link those entities to internal identifiers or external references. The module 22 may determine candidate rules expressed in text by detecting modal statements, obligations, thresholds, conditions, and actions, and may map such statements into predicate form with fields, operators, and values. When tables appear, the module 22 may determine header rows, units, and key columns, and may extract rows into records while preserving source references. When multiple documents pertain to the same subject, the module 22 may align terms, detect duplicates, and resolve conflicts according to policy. In some deployments, document ingest module 22 may cause a knowledge graph to be updated with nodes for documents, sections, figures, and extracted entities, with edges that reflect containment, citation, and semantic relations.

Models tailored for tabular data in module 22 may receive documents that contain grids, implicit tables, or key-value layouts and determine structure before extracting values. A layout analysis stage may obtain line geometry, whitespace, and alignment cues to determine rows, columns, and merged cells even when borders are faint or absent. The models may classify header regions, detect multi-row or multi-column headers, and determine header hierarchies so each data cell can inherit the correct labels. When tables mix text, numbers, and units, the system may normalize formats, parse ranges and inequalities, and associate units found in header lines or footnotes with the correct fields. Optical character recognition may run with table-aware decoding so characters near ruled lines are not split or joined incorrectly, and confidence scores may propagate to each field for later review.

Some embodiments may convert the table into a machine-parsable object that captures cell coordinates, spanning, header bindings, and data types. A relation inference step may determine keys, foreign keys, and groupings by analyzing repeated label patterns, subtotal rows, and sorting indicators. When a table includes embedded references or footnotes, the model may resolve them and cause the referenced text to attach to the correct rows or columns. For semi-structured layouts such as stacked key-value lists, the system may determine pairs and collections, align them to a field schema, and emit consistent records across pages. Postprocessing may detect outliers, fill down repeated labels, and reconcile totals, producing structured rows with provenance that downstream components can query, join with other sources, and evaluate against rules.

Certain embodiments may obtain a document and determine candidate rules (or other structured or semi-structured fields) by segmenting text into sections, clauses, and conditions, then classifying each span for modality such as obligation, prohibition, permission, or recommendation. A parser may detect triggers, subjects, actions, thresholds, time limits, locations, parties, and exceptions, and may resolve cross-references to other sections or incorporated standards. The pipeline may normalize quantities and units, map defined terms to entity types, and detect scope statements that limit when a rule applies. When the document includes tables or figures, the system may bind table fields and diagram annotations to the nearest clauses so numeric limits and labeled components appear as rule parameters rather than free text. Each extracted rule or other field may include provenance to page, paragraph, and coordinate ranges so later stages can present citations and request review.

A machine-readable version of an extracted rule may appear as a structured object that encodes conditions and outcomes. The representation may include a predicate with fields, operators, values, and comparators; a context block with parties, dates, and applicability; and an exceptions list with their own predicates. The system may store rules in a form such as JSON, a declarative policy language, or a graph of nodes and edges that represent conditions, joins, and actions. Confidence measures may attach to each field, with links to the underlying text and any resolved definitions. During evaluation, the platform may obtain evidence records, join them to required fields, and determine pass, fail, or not-determined, while recording which inputs produced which result.

Some rules or other fields may not admit a complete structured form because they use terms such as reasonable, adequate, clear and conspicuous, or material. For such clauses, the system may create a hybrid record that includes structured predicates for the objective elements and a natural-language subrule for the subjective element. The structured portion may check that a disclosure appears near a claim, that a font size exceeds a threshold relative to body text, and that a required term is present. The natural-language subrule may include the original clause text, a rubric, and references to examples drawn from the same document or a cited standard. A language model may receive the evidence, the rubric, the clause text, and any relevant context, determine a score and short justification, and return a result with citations to input passages or images used in the assessment.

As an example, a marketing policy may state that a disclosure must be clear and conspicuous, in proximity to the specific claim, and not obscured. The module 22 may encode proximity and size as structured checks while leaving clear and conspicuous as a natural-language subrule evaluated by a model guided by a rubric that lists readability, placement without scroll, contrast, and absence of competing elements. The evaluation may cause a combined result that shows structured checks as pass or fail and the subjective check as a score with a rationale, each linked to page regions and evidence. In some embodiments, module 22 may generate machine-parsable rules from natural language, evaluate objective elements deterministically, and apply controlled language-model judgments to subjective elements while maintaining an auditable trail from input text to final determination.

For images and diagrams, document ingest module 22 may apply computer vision models configured for technical content. The module may determine diagram type and apply detectors tuned for symbols and notations used in engineering drawings, including mechanical assemblies, piping and instrumentation diagrams, single-line electrical diagrams, printed circuit layouts, and network topologies. The models may identify components such as valves, pumps, bearings, gears, transformers, breakers, chips, connectors, and ports, and may determine links such as wires, traces, pipes, shafts, and buses. The system may infer attributes from standard legends and callouts, obtain units from scales, and derive connectivity graphs that capture nodes, edges, and directions of flow. When diagrams contain embedded text, the module may use optical character recognition guided by detected bounding boxes to associate labels with specific components.

Computer vision models (like convolutional neural networks or vision transformers) may receive an engineering diagram and determine symbols, connections, and labels that together define a machine-parsable representation. A detector may localize symbols and reference marks using convolutional or transformer-based architectures adapted for line drawings rather than natural scenes. The model may learn thin-line and high-contrast features by using kernels and positional encodings tuned to strokes, hatches, and schematic icons. A segmentation head may separate foreground ink from background noise and recover layers such as wires, pipes, traces, and mechanical boundaries. A text detector may identify label regions and an optical character recognition module may recover strings, units, and part identifiers. The system may apply a line and junction extractor to determine polylines, corners, tees, and crossings so later stages can resolve connectivity.

Some embodiments may tailor detectors to symbol vocabularies specific to a domain. A mechanical workflow may prioritize bearings, gears, valves, pumps, shafts, and fasteners, while an electrical workflow may emphasize breakers, transformers, single-line symbols, and bus bars, and a printed circuit workflow may focus on pads, vias, packages, and traces. The detector may use anchors and priors that reflect canonical aspect ratios and orientations found in each symbol set, and may augment training with rotations, small skew, scan artifacts, and partial occlusions that occur in photocopies. A two-stage approach may first identify coarse regions, such as panels or legend boxes, and then apply fine-grained classifiers to distinguish visually similar symbols that differ by a small glyph or tick. When symbol families share shapes, a metric-learning head may separate them using label context, nearby text, and surrounding connections.

Some embodiments may pair detection with vectorization so lines and arcs become parametric primitives. A differentiable vectorization step may fit segments and curves to the segmentation map and may assign confidence to each primitive. A topology solver may then assemble a graph by snapping symbol ports to nearby line endpoints and by resolving ambiguous crossings using learned cues and simple tests such as path continuity and layer priority. A graph neural network may refine this assembly by passing messages along candidate edges and determining which endpoints should connect, which edges carry flow, and which nodes serve as sources, sinks, or junctions. The model may determine attributes by linking OCR (optical character recognition) text to the nearest symbol or edge, guided by arrows, leaders, and callout boxes that a relation detector identifies.

Variations may combine learned models with light rules to incorporate standards that appear in engineering drawings. A rules engine may enforce that certain symbols must expose a fixed number of ports or that certain connections cannot occur in a given standard. The system may determine units from title blocks and legends and may normalize values found in callouts. Template priors may accelerate recognition in recurring subcircuits or repeated mechanical subassemblies; the detector may propose matches and a verifier may confirm them by overlay alignment. When training data is limited, the models may benefit from synthetic diagrams generated from symbol libraries and procedural routers that create plausible networks, with fonts, noise, and compression artifacts applied to match scanned documents.

Some embodiments may operate in a multimodal regime where a vision model and a language encoder exchange features. The model may read a legend to learn symbol meanings for a specific drawing and then condition detection on that local vocabulary. A captioning head may produce short descriptions, such as “three-phase transformer to main bus,” that help align detected structure with known patterns. During postprocessing, the module 22 may determine a bill of materials from symbol counts, a connection table from the graph, and parameter tables from text-linked attributes. Each record may carry source coordinates and confidence so downstream components can present citations and request human review when needed.

Processing may proceed in stages so partial outputs remain useful. The module 22 may first cause a coarse graph with major components and primary paths, then refine ports, polarities, and part numbers, and then determine flow direction using arrowheads and conventions. When ambiguity persists, the model may generate alternatives and rank them using global consistency, such as whether a circuit can supply power from a declared source to all declared loads, or whether a mechanical loop closes without impossible overlaps. Some embodiments of module 22 may output structured records that describe components, connectivity, attributes, and derived rules that downstream agents can evaluate and present.

Document ingest module 22 may combine these analyses to produce structured records, such as executable rules, parts inventories, or the like. The module may output machine-parsable objects that describe entities, attributes, relationships, table rows, diagram components, and connectivity, and may emit rule expressions that downstream agents can evaluate against other documents or data sets. Each output record may include source locations and confidence measures so later stages can determine reliability, request review, or trigger reprocessing. In some embodiments, document ingest 22 may cause unstructured inputs to become structured representations that other components can query, validate, and use during application generation and runtime. In some embodiments, document ingest module 22 may use retrieval augmented generation techniques to search the repository 15, for instance with keyword search, vector search, or the like to identify content relevant to a particular domain for ingest.

In some embodiments, document ingest module 22 may obtain a set of domain documents and cause a domain-specific portion of a knowledge graph to be created or updated. For a compliance workflow, the module 22 may receive policy manuals, guidance letters, and annotated examples, extract defined terms, roles, thresholds, and deadlines, and determine relationships among rules, exceptions, and cited standards. The module 22 may emit nodes for documents, sections, clauses, tables, and figures, and edges that represent containment, citation, dependency, and semantic links such as applies-to, supersedes, or exception-to. Each node and edge may include provenance to page ranges and coordinates, confidence scores, and effective dates so later processes can determine lineage and resolve conflicts. When evaluation documents arrive, such as marketing assets or customer notices, the module may extract claims and disclosures and attach them to the relevant rule nodes, which allows downstream agents to obtain all evidence tied to a rule when determining compliance.

In some cases, document ingest module 22 may receive engineering design packets such as single-line diagrams, mechanical drawings, and parts lists, determine components and connections, and update a graph that captures equipment, attributes, and connectivity. The module may create nodes for transformers, breakers, pumps, shafts, bearings, nets, and signals, and edges for electrical, mechanical, or fluid links with direction and capacity. OCR results and callouts may populate attributes such as ratings, tolerances, setpoints, and materials. The module may link components to vendor datasheets and maintenance logs already present in the repository and may attach rule expressions that derive from safety codes or internal standards. In some embodiments, the knowledge graph may reflect a live view of the domain where documents supply facts, diagrams supply structure, and rules attach to the affected entities, helping later agents to access the graph to answer questions, generate views, and evaluate conformance.

Certain embodiments may include a UI planner 24 that receives a mission description or other objective, determines domain and user context, and produces a plan that the UI generator 26 can render (or generate code that when executed causes rendering of a UI) and wire to data and agents. The planner 24 may access policies, themes, and persona settings from tenant administration and may obtain constraints such as device class, screen size, latency targets, and data locality. The planner 24 may interpret the mission using a reasoning model that identifies tasks, inputs, outputs, and review points, then determine the sequence of views and interactions that satisfy those tasks. In some cases, the planner 24 may reuse prior solutions by retrieving similar missions and adapting their layouts and bindings to current requirements.

The planner 24 may decompose a mission into view models, component requirements, and data contracts. A view model may describe what a screen shows, what actions a user can take, and what evidence or results must appear. Component requirements may define the set of widgets, such as file uploaders, tables, charts, forms, galleries, graph visualizations, and result panels, while data contracts may define the fields, types, and provenance needed by those widgets. The planner 24 may determine which task-specific or domain-specific agents can supply each contract, may assign agents to components, and may define the order of calls and caching behavior so responses arrive predictably. For compliance and engineering workflows and the like, the planner 24 may include slots for citations, rule explanations, diagram callouts, and relevance scores and may ensure that each slot receives coordinates or references to the source material.

The planner 24 may select and arrange components using a mix of learned and constraint-driven methods. A layout solver may accept constraints that cover alignment, spacing, minimum readable sizes, and touch targets, then produce a grid or flex layout that adapts across breakpoints. A content negotiation step may determine responsive variants for each component so dense tables collapse into cards, chord diagrams switch to lists when space is limited, and force-directed graphs add overview and focus panels on large displays. The planner 24 may evaluate alternatives under objective functions that consider readability, scannability, interaction cost, and evidence visibility, and may choose a layout that satisfies those constraints with margin for localization and accessibility. The planner 24 may also assign stable identifiers to components and data bindings so the runtime 32 can hot-swap code without losing session state (or some embodiments may not hot swap versions).

The planner 24 may generate interaction logic as state machines and event specifications. A state machine may define idle, loading, success, and error states for each view and may specify transitions on events such as submit, select, expand, and filter. Event specifications may include handler signatures, expected payload shapes, debounce or throttle hints, and retry policies. For data-binding, the planner may produce queries and selectors that pull from caches, agent outputs, and repository fetches, and may include guards that check permissions and redaction rules before rendering sensitive values. Where subjective assessments appear, the planner may include a rubric slot that the runtime passes to a language model, and a scoring slot that captures the model's output with a justification and links to cited passages or image regions.

The planner 24 may tailor outputs for accessibility and auditability. Accessibility directives may set landmarks, roles, keyboard paths, color contrast targets, and alternatives for canvas-based charts. Audit directives may require that every displayed result carries a provenance link back to a page range, a diagram region, or an agent call with parameters. When conflicts or low-confidence fields appear, the planner may insert review widgets that allow a user to request clarification, view competing interpretations, or trigger reprocessing with different parameters. The planner 24 may also determine telemetry points so the feedback module 34 can collect interaction data and error traces without capturing sensitive content.

The planner 24 may interact with the controller 20 and an orchestrator of agents during both planning and runtime. During planning, the controller 20 may obtain the mission and constraints, the planner may propose a draft plan, and the controller may request validation from domain agents that check feasibility and compliance. During runtime, the planner 24 may emit incremental updates when user feedback indicates a layout change or when a data contract changes, and the controller 20 may cause the UI generator 26 to apply those updates as patches. The planner 24 may also provide fallback pathways when an agent is unavailable, including degraded views that surface partial results with clear indications of completeness.

The planner 24 may use several algorithmic variants to produce its plans. A language-to-plan model may generate a first-pass specification from the mission text, which a constraint solver may refine. A retrieval component may suggest component patterns based on similar missions, such as two-pane compare views for compliance or topology plus table for network analysis. A ranking model may score candidate layouts using signals derived from readability metrics, historical success on similar tasks, and device characteristics. For complex visualizations, the planner may run a miniature simulation that populates components with representative data to verify that labels fit, legends remain legible, and interactions complete within latency targets.

Outputs from the UI planner 24 may appear in formats suited to the UI generator 26. A structured plan may be emitted as JSON that describes views, components, bindings, events, state machines, and constraints. A component tree may be emitted as an abstract syntax tree that the generator can translate to framework code. A style and theme bundle may define tokens for spacing, type scale, color roles, and motion durations. A data contract map may list endpoints, agent calls, cache lifetimes, schema versions, and provenance fields. An interaction map may specify handler stubs and middleware hooks for validation, authorization, logging, and redaction. A patch stream may represent diffs between versions so the generator can apply changes without recompiling the whole application.

For targets that favor web delivery, the planner 24 may produce a virtual DOM description or a framework-neutral intermediate representation that the generator translates into components such as React™, Web Components, or server-rendered templates. For native or hybrid targets, the planner may emit a platform-neutral structure that the generator maps to native widgets while preserving accessibility roles and navigation models. In some cases, the output may include stable identifiers and compatibility notes so existing state, focus, and scroll positions carry forward when a new version arrives.

The planner 24 may also emit artifacts that support development, testing, and governance. A fixture set may include small example payloads that exercise empty, typical, and edge cases for each component. A contract test specification may describe required fields and validation rules so the runtime can detect schema drift. A policy map may record where personal or confidential data appears so masking and consent prompts occur at the right time. Theme hooks may allow a tenant to apply brand settings without changing layout logic, and localization hooks may reserve space for longer strings and right-to-left scripts.

Certain embodiments may include a UI generator 26 that receives plans, component trees, data contracts, and interaction maps from the UI planner 24 and causes executable user interfaces to be produced and updated. The generator 26 may accept a structured specification that describes views, components, bindings, events, and state machines, then determine framework targets and rendering strategies. The generator 26 may translate an abstract component tree into concrete widgets, assign stable identifiers, and produce code for event handlers and data adapters so views render and respond without manual wiring. When the planner 24 supplies a patch stream, the generator 26 may apply diffs that change components, layout constraints, and bindings while preserving session state, focus, and scroll positions.

The UI generator 26 may support multiple targets and may select an appropriate output format based on deployment goals. For web delivery, the generator 26 may emit framework code such as React™ components, web components, or server-rendered templates, and may include code splitting and lazy loading for large visualizations. For native or hybrid environments, the generator may map the same intermediate representation to native widget sets while keeping accessibility roles and navigation models consistent. In some cases, the generator may use a virtual DOM (document object model) or a platform-neutral layout engine to ensure that responsive rules and content negotiation behave the same across devices. Theme tokens and localization hooks provided by the planner may be compiled into style bundles that control spacing, type scale, color roles, and motion, with runtime switches for dark mode and right-to-left scripts.

The generator 26 may implement interaction logic by materializing (e.g., generating the code for) the state machines and event specifications from the plan. Each view may have defined idle, loading, success, and error states, and transitions may be wired to user actions and agent responses. Event handlers may include validation, debouncing, retries, and authorization checks, and may call agent endpoints or repository connectors according to the data contracts. The generator 26 may set up data stores and selectors that hydrate components from caches and live calls, and may attach guards that prevent rendering of redacted fields. Where subjective assessments are requested, the generator 26 may deliver rubric text, evidence snippets, and image regions to the language model interface and may capture scores and justifications with provenance links.

Rendering of complex visuals may be optimized by choosing canvas, SVG (scalable vector graphics), or WebGL based on size and interactivity. The generator 26 may produce (code and assets that form) clustered graphs, force-directed graphs, chord diagrams, timelines, and topology views and may attach tooltips, focus rings, and keyboard paths that satisfy accessibility requirements. When space is limited, the generator 26 may apply responsive variants specified by the planner so dense tables collapse into cards and graphs offer overview plus detail panels. For diagram callouts and citations, the generator may embed coordinate anchors and bounding boxes so a user can jump from a rule or result to the precise page region or symbol in the source document.

Runtime safety and governance may be enforced by isolating untrusted content and restricting permissions. The generator 26 may set content security policies, sandbox third-party widgets, and separate credentials from front-end bundles. Secrets and keys may remain in server-side services, while the client receives scoped tokens with limited lifetimes. Telemetry points defined by the planner may be instrumented to record latency, errors, and interaction patterns without capturing sensitive payloads. The generator 26 may write audit traces that connect each visible result to the agent call or repository read that produced it, including parameters and version identifiers for models and rules.

Build and update workflows may favor incremental compilation and hot replacement. The generator 26 may cache compiled templates and keep a mapping from stable identifiers to component instances so a new version can replace logic without discarding local edits or selections. When schema versions change, the generator 26 may consult the contract tests provided by the planner and may insert compatibility shims or request re-planning. If an agent is unavailable, the generator 26 may activate degraded views that display partial results and suggested next steps, then restore full interactions when services resume. Error boundaries may capture failures at component granularity and present clear messages with retry options rather than halting the whole application.

Testing and quality controls may be produced alongside the application code. The generator 26 may create fixtures that exercise empty, typical, and edge cases and may run snapshot and interaction tests to confirm that rendering and state transitions match expectations. Accessibility checks may verify roles, labels, tab order, and contrast before deployment. Performance budgets may be enforced by rejecting bundles that exceed size or by inserting dynamic imports where large dependencies appear. The generator 26 may emit sourcemaps, diagnostics, and lint outputs so operators can trace issues in production without exposing source.

Outputs from the UI generator 26 may include executable code bundles, server-rendered pages, or native packages, along with manifest files that describe component versions, data contracts, and provenance fields. The generator 26 may also emit a registry entry that allows the runtime 32 to discover views, routes, and permissions, and a patch artifact that expresses the delta from the prior version. For environments with strict change control, the generator 26 may produce a signed artifact that records hashes of code, schemas, and policies, enabling verification at load time.

Certain embodiments may include domain specific agents 28 that receive tasks within a known sector (or other type of domain) and return analyses, extractions, and decisions tuned to that sector's data and practices. The controller 20 may obtain an objective, determine that it pertains to a given domain, and cause the relevant agent set to engage. Selection may use signals such as detected terminology in the objective and ingested documents, source system identifiers, file templates, and knowledge graph context. The controller 20 may query a registry of agents, obtain capability descriptors and schemas, rank candidates by domain fit and confidence, and invoke one or more agents with inputs and policies appropriate to the enterprise.

In finance, a domain agent may access account ledgers, exception files, and payment messages and determine derived features such as counterparty profiles, transaction patterns, and exception categories. Another agent may parse check images and advice files, recover routing and account fields, and cause validation against internal formats. A portfolio analysis agent may obtain positions, price histories, and risk factors and determine exposure summaries and limit checks that a view can present alongside citations to the underlying rows. When a marketing review objective arrives, a policy agent may extract claim and disclosure pairs from assets and apply formatting and proximity rules, while a records agent may determine retention requirements based on document class and effective dates.

In healthcare, a clinical documentation agent may receive progress notes, lab panels, and imaging reports and extract problems, medications, orders, and timelines mapped to local code systems. A quality review agent may determine whether required elements appear in discharge instructions and cause a checklist view with links to note sections and scanned pages. A trial operations agent may obtain protocol documents, visit schedules, and case report forms and determine windows, dosing rules, and adverse event triggers, then emit structured rules that downstream components can evaluate against site activity and sensor feeds. The controller 20 may pass de-identification policies to these agents and obtain outputs that preserve lineage to source pages while masking fields marked as sensitive.

In manufacturing, a product definition agent may ingest bills of materials, routings, and revision histories and determine structure, alternates, and effectivity. A quality agent may access inspection records and machine telemetry and determine defect patterns and process capability metrics, then cause a dashboard that links charts to the exact lots and stations. An engineering diagram agent may analyze single-line or mechanical drawings, detect components and links, and output connectivity graphs and part attributes that a downstream view can render as topology plus table. When a supply objective arrives, a planning agent may obtain lead times, purchase orders, and inventory snapshots and determine shortages and mitigation options with references to the originating records.

Other sectors may rely on agents with similar patterns. In energy, an operations agent may obtain SCADA (supervisory control and data acquisition) tags and alarms and determine event summaries per asset and feeder, while a maintenance agent may join work orders and condition data to recommend actions. In media, a rights agent may read contracts and metadata to determine permitted uses and expirations and cause warnings when an edit timeline includes assets that exceed scope. In research and education, a grants agent may parse calls, budgets, and compliance checklists and determine required submissions and dates, and a publications agent may extract authors, affiliations, and embargo terms and attach them to repository items.

The controller 20 may coordinate these agents as part of a plan from the UI planner 24. It may determine input contracts, obtain outputs, validate schemas, and merge results so the UI generator 26 can bind components without manual wiring. When an objective spans multiple domains, the controller 20 may invoke more than one domain agent and reconcile overlaps using precedence rules and confidence scores. Agents may return structured records, rule expressions, explanations, and provenance, along with capability hints that allow re-use during runtime when a user filters, drills down, or requests a recalculation. In some embodiments, the domain specific agents 28 are expected to allow applications to present sector-correct views and actions while preserving traceability to enterprise sources. The domain specific agents may be used both during generation of a software application and during execution of the software application, for instance, as resources called by that software application.

Certain embodiments may include task specific agents 30 that receive narrowly defined jobs and return structured outputs usable across domains. The task specific agents may also be used both during generation of a software application and during execution of the software application, for instance, as resources called by that software application. The controller 20 may obtain a mission, determine the sequence of steps from the UI planner 24, and cause one or more task agents to execute functions such as optical character recognition, table detection, named-entity extraction, de-duplication, data quality checks, rules evaluation, vector indexing, retrieval, summarization, translation, redaction, and unit normalization. These agents may expose capability descriptors and schemas so the controller 20 can determine inputs, outputs, and latency characteristics and may return results with provenance and confidence values that downstream components can display or review.

In a compliance workflow, document ingest 22 may pass a scanned policy to an optical character recognition agent to recover text and coordinates, then cause a table parser to extract limits and thresholds into rows, and invoke a rule extractor to emit predicate forms with exceptions. A retrieval agent may index the recovered text and figures, and a citation agent may determine page and region links for any later answer. When a user submits a marketing asset for review, a claim extraction agent may obtain statements and disclosures, a layout analyzer may determine proximity and contrast, and a rubric scorer may produce a relevance score and rationale that the interface displays with jump-to-source actions. The controller 20 may coordinate retries and fallbacks, such as using a secondary optical character recognition engine when confidence is low or a language model-based table reader when borders are missing.

In healthcare, a named-entity agent may map problems, medications, and procedures to local codes, while a timeline agent may order events and determine gaps relative to protocol windows. A de-identification agent may mask identifiers before any downstream visualization, and a quality check agent may determine whether required discharge elements appear. The controller 20 may enforce policies that restrict which records each agent can access and may record lineage so each checklist item links to note sections and scanned pages. When a user drills into an outlier, a summarization agent may obtain the most relevant passages and cause a short explainer to appear alongside citations and confidence scores.

In manufacturing and engineering, an image segmentation agent may separate foreground ink from background and feed a symbol detector that returns components with ports. A vectorization agent may convert lines and arcs into primitives and a topology agent may determine connectivity graphs with flow directions. A unit harmonization agent may normalize tolerances and ratings, and a comparison agent may determine differences across revisions and cause highlights in both drawing and table views. When a supply analyst requests risk, a join agent may link bills of materials to supplier data and lead times, a scoring agent may compute shortage risk, and a mitigation agent may propose substitutes with references to approved alternates.

Across finance and other sectors, task agents may include validators that check field formats, joiners that align records across systems, deduplicators that merge near-matches, and redaction agents that remove sensitive values before display. A retrieval-augmented generation agent may accept a question, access indexed sources, and return an answer with citations, while a relevance agent may score multiple model responses and cause the interface to present a consolidated result. The controller 20 may compose these agents into pipelines based on the plan, pass cache hints and timeouts, and select variants tuned for speed or accuracy.

Certain embodiments may include a runtime 32 that receives build artifacts from the application development system 12 and causes an application to execute for users. The runtime may obtain the component code, data contracts, event specifications, and provenance directives produced by the UI generator 26 and may determine how to load them for a given device and tenant. The runtime may manage sessions, maintain view state, and apply updates while preserving focus and scroll positions. The runtime may access the enterprise data repository 15 and agent endpoints according to policy and may enforce authentication, authorization, and redaction before rendering results.

Examples of a runtime may include a browser-based client that executes web bundles with server helpers, a native container that hosts views on desktop or mobile, and a server-side renderer that produces pages and streams updates to thin clients. In some deployments the runtime may operate in containers behind an API gateway, while in others it may run as serverless functions that scale with demand. The runtime may determine where to execute a step (e.g., on the client for responsiveness, on the server for data locality, or within a private subnet for sensitive calls) and may route requests over network 18 using private endpoints when available.

During operation, the runtime may obtain inputs from user devices 16, call task specific agents 30 and domain specific agents 28 through the controller 20, and bind outputs to views defined in the plan. State machines from the plan may drive loading, success, and error transitions, and handlers may implement validation, retries, and fallbacks. When the feedback module 34 signals a change, the runtime may apply a patch to modify components, layouts, or bindings without restarting the session. If a new version arrives, the runtime may substitute it for the prior version and cause state to carry forward so users continue without interruption.

The runtime 32 may record audit trails and telemetry without exposing sensitive content. Each displayed result may carry references to the agent call or repository read that produced it, including parameters and model versions. The runtime 32 may determine performance budgets and cause large visualizations to load lazily, may cache data according to the plan's directives, and may invalidate caches when schemas change. In a multi-tenant setting, the runtime 32 may isolate configuration, themes, and data access, and may apply tenant policies that control which agents and repositories a session can reach.

Resilience features may include circuit breakers, backoff policies, and degraded modes that present partial results when services are unavailable. The runtime 32 may detect schema drift using contract tests shipped with the plan and may request re-planning or apply compatibility shims. Error boundaries may capture failures at component granularity and present clear messages with options to retry or view citations for context.

Feedback module 34 may receive natural-language (e.g., complaints or feature requests) or structured language comments (e.g., thumbs up/down, ratings from 1-5, etc.) from the user who provided an objective and from other users of the generated application. The module 34 may obtain text typed into comment fields, transcripts from voice input, and signals from in-app prompts that ask what worked and what did not. The module 34 may parse this input, determine targets such as a specific view, component, rule, or data contract, and extract intents such as add a field, change a layout, relax a threshold, or fix a failing check. When feedback refers to evidence, the module may access citations and coordinates so the controller 20 can reproduce the context. The module 34 may also accept attachments such as example documents or screenshots and may link them to the affected plan elements for review and traceability.

Feedback module 34 may also obtain programmatic signals that indicate correctness and quality. The module 34 may run unit tests and interaction tests produced with the application, verify schema contracts, and execute probes that check accessibility, performance budgets, and security guards. When a check fails or a threshold is exceeded, the module may determine which component or data contract is implicated and record a machine-parsable finding with provenance. The module 34 may aggregate human and automated feedback, prioritize items by severity and frequency, and cause the controller 20 to select a regeneration path such as re-planning a view, modifying a handler, swapping an agent variant, or updating a rule expression.

When changes are warranted, the module may direct the controller 20 to obtain an updated plan from the UI planner 24 and cause the UI generator 26 to produce a new version of the affected parts. The controller 20 may determine whether a full rebuild or a patch suffices and may request diffs that isolate only the modified components, layouts, or bindings. The runtime 32 may receive the update during the current session and substitute the new version for the prior one while preserving program state such as selected rows, filters, scroll positions, focus, cached results, and pending requests where safe to do so. If certain state is incompatible, the module may determine a migration map that transforms values into the shapes expected by the new code.

In some cases, the module 34 may stage the change behind a toggle or limited rollout, obtain confirmation from the reporting user, and then cause broader activation. The module 34 may capture before-and-after telemetry to verify that an issue no longer occurs and that performance remains within targets. If the update degrades behavior, the module may direct the controller 20 to revert and request a revised plan. In some embodiments, feedback module 34 may cause applications to evolve during live use without disrupting the session or cause generated applications to evolve between sessions.

A generated software application may include user interface code, server logic, data contracts, models, and supporting assets that the application development system 12 obtains from plans and causes to be built. The application may present views, accept inputs, call agents, and display results with citations and provenance. The build may include artifacts such as executable bundles, configuration files, schemas, test fixtures, release notes, and deployment manifests. Visual assets may include icons, diagram callouts, and images that a diffusion model produces from prompts, with alt text and usage licenses attached for audit. Code artifacts may include handlers, state machines, policy checks, and adapters that connect to enterprise systems.

Some deployments may generate a monolithic executable that contains both front-end rendering and back-end logic. The system 12 may package a single binary or archive that embeds templates, routing, and data access layers, and may run it as a service or a desktop app. The monolith may expose an internal API (application program interface) for user devices 16 while keeping data processing local to a secure subnet, and may log lineage and metrics to enterprise stores. In other cases, the build may produce a front end and a back end as separate deliverables. The front end may render UI components in a browser or a native shell and may call the back end over network 18 using endpoints that the plan defines. The back end may host rules evaluation, retrieval, and aggregation, and may cache responses according to policy.

Client-side only variants may load a static bundle that runs entirely in the browser or a native Web View. The bundle may obtain data from the enterprise data repository 15 through preauthorized gateways, apply rules in the client, and render graphs and tables without a dedicated server. This mode may suit read-heavy tasks or environments where server compute is restricted. Web application variants may include server-rendered pages, single-page applications, or hybrid models that stream updates. Native application variants may target desktop or mobile and may package compiled code with platform widgets, offline stores, and background tasks, while preserving accessibility roles and navigation models defined in the plan.

Packaging may vary by target. The system 12 may emit container images with health checks and resource limits, archives with hashed assets and content security policies, signed desktop installers, or mobile packages for internal distribution. The build may include sourcemaps and diagnostics for operators, and signed manifests that record versions of models, rules, and schemas. For rich visuals, the artifacts may include prerendered thumbnails, sprite sheets, and font subsets that improve load time. For generated images, the package may include prompt metadata and license terms so reviewers can trace sources and approve usage.

Hosting may occur inside the enterprise data repository 15 or services adjacent to it. Source code and manifests may reside in a code repository, and compiled bundles may appear in a binary registry. Desktop and mobile packages may be published to an internal application store, while web bundles may deploy to a private content delivery path with access controls. The repository may retain prior versions and signatures so the runtime 32 can verify integrity and roll back if needed. In some environments, an external app store may distribute approved builds with enterprise provisioning, and the repository 15 may keep the corresponding source and evidence for audit.

In some embodiments, the generated application may preserve stable identifiers for components and data bindings so updates can substitute a new version during a session without losing context. The packaging may carry policy files that define permissions, redaction, telemetry, and retention. In some embodiments, the system 12 may cause applications to be deployed, updated, and reviewed in a manner that aligns with enterprise controls.

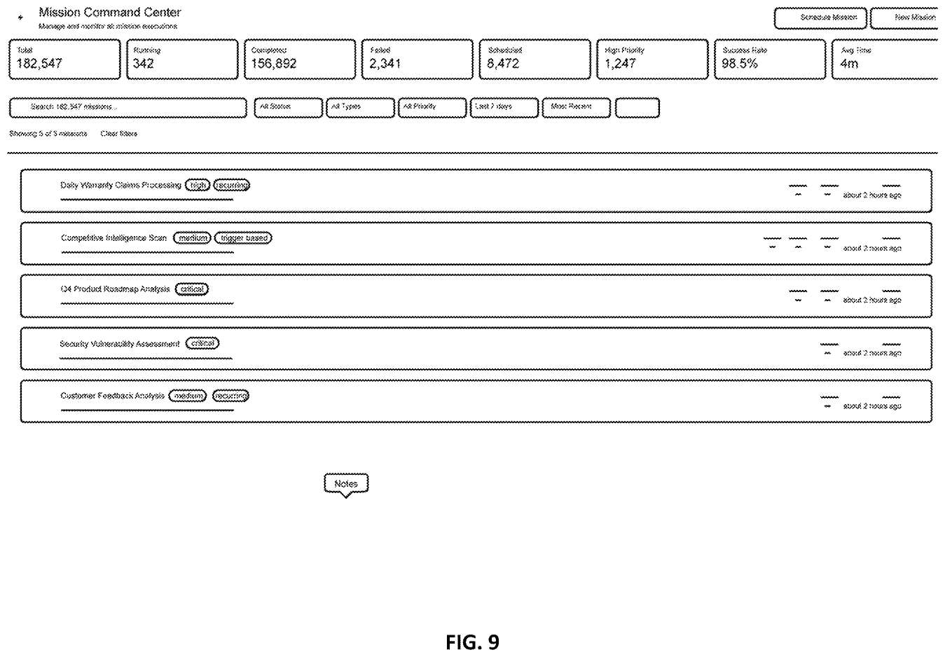

Certain embodiments may include a dashboard generator 36 that receives telemetry and build artifacts from the application development system 12 and causes a dashboard to be presented with usage, version identifiers, resource consumption, and other statistics for generated applications. An example is shown in FIG. 9 and described below. The dashboard generator 36 may obtain counts of active users and sessions, request rates to domain specific agents 28 and task specific agents 30, cache hit ratios, latency percentiles, error types, and peak memory or CPU during generation and runtime. The component may determine lineage for each metric to the underlying plan, model version, and data contract and may present charts, tables, and timelines that allow an operator to filter by tenant, application, version, or environment. In some cases, the dashboard generator 36 may access cost and quota data and cause rollups that show the resources consumed by specific plans, agents, or visualization types.

The dashboard generator 36 may also serve as an interface by which a user requests updates and submits feedback. A user may select an application and a version, enter natural-language comments, attach example documents, and request a change such as adding a field, modifying a workflow, or upgrading an agent variant. The dashboard generator 36 may obtain these inputs, determine the affected views and contracts, and direct the controller 20 to initiate regeneration or to create a new copy of the application. Where safe, the controller 20 may cause a patch that substitutes the updated version during active sessions while preserving state, and the dashboard may display the status of that substitution along with any migration steps that were applied.

Feedback may also arrive from within the applications themselves, and the dashboard generator 36 may obtain those signals from the feedback module 34 and present them alongside automated checks such as unit tests, contract tests, accessibility probes, and performance budgets. The dashboard may determine priorities based on severity and frequency and may cause notifications to owners when thresholds are crossed. Administrative users may access controls that schedule rollouts, pin versions, or revert to a prior build, with the dashboard writing audit records of requests, approvals, and outcomes. By receiving telemetry and comments, presenting actionable context, and coordinating with the controller 20 and feedback module 34, the dashboard generator 36 may provide a central place to observe generated applications and to request and track changes.

Certain embodiments may host AI agents within the AI platform 14 and expose their capabilities to the application development system 12 through defined interfaces. The controller 20 may obtain an objective, determine that one or more agents pertain to the domain and tasks at hand, and cause those agents to execute on the AI platform 14. In other deployments, a generated software application may call AI agents 42 of the AI platform 14 directly at runtime to obtain extractions, summaries, classifications, or code updates. The same planning and data-contract logic may govern these calls so inputs, policies, and provenance travel with each request, and so outputs appear in the views that the UI generator 26 renders (e.g., generates code that when executed causes a client to render). Selection of where an agent runs may depend on tenant policy, data locality, latency targets, and cost, and the controller 20 may determine whether to route a call to an agent co-located with enterprise resources or to a shared, multi-tenant instance on the AI platform 14.

AI models 42 used by agents may execute on remote infrastructure while still being treated herein as part of the component that calls them. For instance, an agent wrapper may receive a request, apply redaction and validation, forward inputs to a hosted model over a secure channel, obtain outputs, attach model and policy versions, and return a structured result under the agent's contract. From the perspective of this specification, the agent that performs these steps remains the executing component even when inference occurs on remote hardware, because the calling agent controls preprocessing, invocation parameters, postprocessing, and delivery of machine-readable results with provenance. This arrangement may allow the application development system 12 and the AI platform 14 to swap or version models without changing plans or bindings, and may allow the runtime 32 to obtain auditable, reproducible outputs while keeping sensitive data within approved boundaries.

In some embodiments, the AI platform 14 may include an orchestrator 40 and multiple artificial intelligence models 42 exposed through service interfaces. The orchestrator 40 may accept incoming requests that may include a system prompt, a content prompt, and decoding settings, may parse routing metadata such as model identifiers and stage assignments, and may dispatch the request to one or more artificial intelligence models 42 according to configured policies. The orchestrator 40 may maintain per-request context such as correlation identifiers, may apply rate limits and batching rules, and may sequence multi-stage flows by issuing a series of sub-requests in which outputs from earlier stages may be transformed and forwarded to later stages. The orchestrator 40 may record request and response metadata, may handle retries on transient failures, and may expose streaming or non-streaming response modes to downstream consumers.

In some embodiments, each artificial intelligence model 42 may provide an inference endpoint that may accept prompt text and decode settings and may return a response payload containing generated text and optional auxiliary data such as token counts, per-token scores, or tool-call traces. The artificial intelligence models 42 may represent distinct model families or versions and may support configurable decoding parameters, schema guards, and resource controls communicated by the orchestrator 40. The models 42 may support reuse of intermediate state across related requests within time windows, may emit partial results during generation when requested, and may surface diagnostics that may be persisted by the AI platform 14. The AI platform 14 may maintain registrations for available artificial intelligence models 42, may publish their capabilities to the orchestrator 40, and may provide administrative interfaces through which configurations and stage definitions may be updated without interrupting request handling.

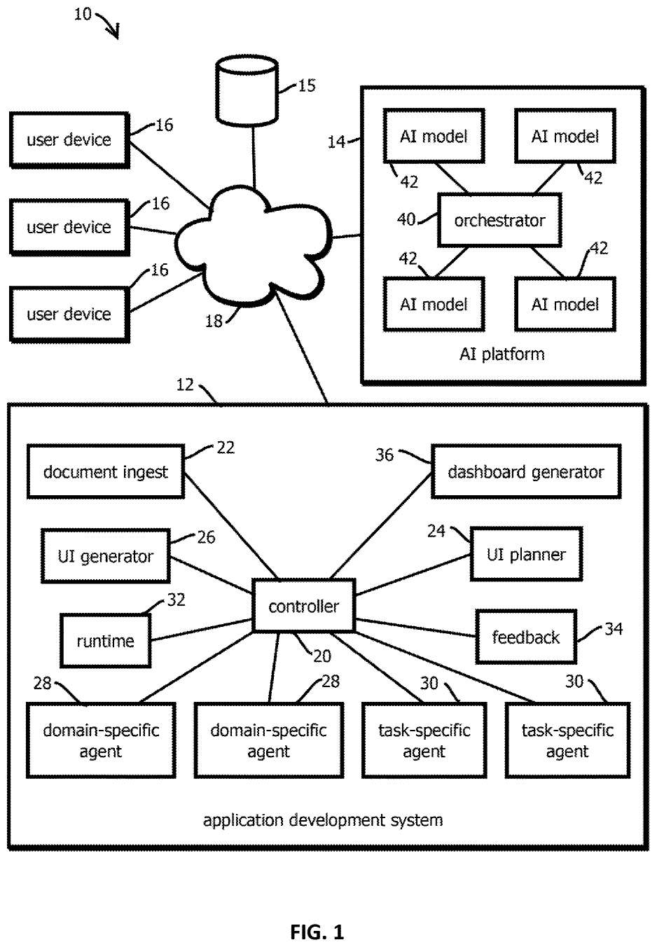

By way of example, the illustrated AI platform 14 has four artificial intelligence models 42 in FIG. 1 for clarity, while other embodiments may register substantially more models and versions at once (e.g., more than 10, more than 100, more than 1,000, or more than 10,000). The platform may maintain a catalog in which each model 42 may advertise input and output modalities, supported decoding settings, schema constraints, resource limits, and health status. A controller or orchestrator 40 may read this catalog to select one or more models 42 for a request, while administrative interfaces may allow models to be added, disabled, or rolled back without interrupting service. Models 42 may be addressed individually or through stage aliases so that a pipeline may target a class of models rather than a single identifier, which may allow staged migrations and A/B splits across a fleet.

In some embodiments, models 42 may be trained separately or together. Separate training may proceed in its own pipeline per model: ingest training data, prepare batches, run forward passes, compute a loss signal according to the task, and apply parameter updates; checkpoints may be exported and registered when validation may meet a gate. Concurrent training may coordinate two or more models in a shared loop, for example by distilling a teacher model into a smaller student, by alternating updates between a retriever and a generator, or by sharing embeddings that may be updated jointly. A scheduler may partition accelerators across jobs, synchronize checkpoints at specified intervals, and write model cards that may summarize training data windows, hyperparameters, and evaluation scores so that the orchestrator 40 may route requests only to models that may satisfy deployment policy.

In some embodiments, the models 42 may be multimodal and heterogeneous. A text model may accept prompts and emit text; a vision model may accept images and emit labels, captions, or embeddings; an audio model may accept waveforms and emit transcripts or speaker turns; and a diffusion model may accept text and emit images through iterative sampling. Cross-modal adapters may be registered to convert outputs from one model to inputs for another, for example mapping an image encoder's embedding to a language model's hidden space, or converting a transcription into a structured prompt template. The orchestrator 40 may attach these adapters based on a stage definition so that heterogeneous models may be composed into a single request path.

In some embodiments, a large language model may be represented as a sequence model that may consume tokenized prompts and, during inference, may maintain a working cache of intermediate state while producing the next token repeatedly until a stop rule may be met. Training such a model may follow a loop that may read batches of token sequences, run forward passes to predict the next token at each position, compare predictions to references to compute a loss, and update parameters; fine-tuning may continue this loop on domain examples, and instruction-tuning may add formatting and constraint-following demonstrations. Decoding at inference may be controlled by settings such as sampling temperature, nucleus probability, maximum tokens, repetition penalties, and stop sequences, all of which the AI platform 14 may apply per request.

In some embodiments, a state space model may process long sequences by maintaining a compact state that may be advanced with each new input chunk. During inference, the model may read a segment of tokens or features, update its state using learned transition operators, and emit outputs for that segment; this segment-wise procedure may allow long contexts to be processed in a streaming manner. Training may sweep over long sequences with sliding windows, apply teacher forcing for stability, and update parameters based on a prediction or reconstruction objective. The platform may expose the state as an opaque handle so that later stages may continue from the same point without reprocessing earlier chunks.

In some embodiments, a diffusion model may synthesize or transform images by iteratively refining a noisy representation. During inference, the model may start from noise seeded by a sampler, and in a fixed number of steps may apply learned denoising updates that may be conditioned on a text prompt or an image reference. Schedulers may determine step sizes, and guidance scales may adjust adherence to conditioning. Training may proceed by adding noise to ground-truth images at sampled levels, asking the model to predict the noise or a denoised target, and updating parameters to reduce the prediction error. The platform may wrap this procedure behind an endpoint that may accept text, images, and control hints such as masks or edge maps.

In some embodiments, a computer vision model may perform classification, detection, segmentation, or optical character recognition. During inference, the model may read an image tensor, compute hierarchical features with convolutional or attention-based blocks, and emit class probabilities, bounding boxes, masks, or extracted text. Post-processing may apply thresholding and non-maximum suppression. Training may construct batches with augmentations, run forward passes to produce predictions, compute task-specific losses, and update parameters. The platform may expose pre-processing and post-processing steps as configurable handlers so that outputs may be normalized before being passed to later stages.

In some embodiments, a reinforcement learning model may interact with an environment to learn a policy. During training, the agent may observe a state, choose an action according to a policy network, receive a reward, and update the policy and, for example, a value estimator using stored trajectories. Curriculum schedules may adjust difficulty, and off-policy replay buffers may stabilize updates. During inference, the agent may read state representations and emit actions without parameter updates. The platform may host simulators or connect to external environments, and may expose the policy behind an endpoint that may accept state observations serialized from an upstream stage.

In some embodiments, additional model classes may be registered, including retrieval models that may rank passages, speech models that may perform recognition or synthesis, program synthesis models that may emit code, and graph models that may reason over structured relations. Each model 42 may define supported settings, pre-processing contracts, and output schemas, and the AI platform 14 may route requests so that heterogeneous and multimodal components may be composed into a single flow, whether four models are displayed in a figure or many more may be present in a deployment.

In some embodiments, the orchestrator 40 may coordinate the plurality of artificial intelligence models 42 by accepting a request that may include a system prompt, content prompt, context references, and routing hints, constructing an execution plan, and issuing a sequence of sub-requests to selected models 42 according to that plan. The orchestrator 40 may parse the incoming payload, may attach correlation identifiers, and may initialize a call graph that may record nodes for planned model invocations and edges for data dependencies among those nodes. The orchestrator 40 may evaluate routing policy to choose model 42 identifiers for each node, may assign decoding settings per node, and may submit sub-requests in an order that may satisfy data dependencies. As responses may arrive, the orchestrator 40 may extract artifacts such as generated prompts, structured fields, embeddings, or tool traces, may normalize these artifacts to a shared interchange format, and may inject them as inputs to downstream nodes in the call graph.

In some embodiments, the orchestrator 40 may implement agentic workflows by hosting a reasoning component that may construct and revise a plan at runtime. The reasoning component may run inside the orchestrator 40 or may be implemented as one of the artificial intelligence models 42. The reasoning component may ingest the user objective and available tools, may propose a sequence of steps that may reference specific model 42 capabilities, and may emit a plan object containing steps, branching conditions, and data mappings. The orchestrator 40 may execute the plan by iterating steps: submit a call to the designated model 42 with a prompt assembled from the current context; await a response; evaluate guard conditions expressed as simple checks or scoring functions; and either proceed to the next step, branch to an alternate step, or request a plan update from the reasoning component when checks may not pass. The orchestrator 40 may maintain a working memory that may store intermediate prompts and outputs and may serialize that memory so that later steps may reference earlier results without repeating prior calls.

In some embodiments, the orchestrator 40 may route requests among heterogeneous models 42 and may transform outputs from one model into inputs for another. For example, a vision model may emit a caption and detected entities that the orchestrator 40 may combine with a system prompt for a language model to generate a report; a retrieval model may emit passages and scores that the orchestrator 40 may attach as context to a question-answering prompt; a diffusion model may produce an image that the orchestrator 40 may pass to a second vision model for safety checks before releasing to a caller. These transformations may be expressed as adapters that may map fields, add delimiters, or enforce schema guards. The orchestrator 40 may also support fan-out and fan-in patterns in which a step may branch to multiple models 42 in parallel with varied prompts or settings, followed by an aggregation step that may select or merge the results using rules or a separate evaluator model.

In some embodiments, the orchestrator 40 may incorporate quality evaluation during execution. The orchestrator 40 may attach evaluators that may score intermediate responses against label functions, constraint checkers, or comparison heuristics, and may record those scores with the call graph. If a score may fall below a configured bound, the orchestrator 40 may trigger a retry with adjusted settings, may select an alternate model 42, or may ask the reasoning component for a revised plan. The orchestrator 40 may maintain stop conditions such as reaching a target score, exhausting a model 42 list, or hitting a budget of calls, and may terminate the workflow when a stop condition may be met. Final outputs may be assembled from nodes designated as sinks in the call graph and may include generated text, structured records, and provenance that may list model 42 identifiers, prompts, and settings used.

In some embodiments, prompt composition inside the orchestrator 40 may be dynamic. A node may specify a template whose placeholders may be filled with values produced by upstream nodes, such as inserting extracted fields, reformatting tables, or embedding citations. The orchestrator 40 may construct prompts by concatenating a system prompt and a content prompt and may append context documents or summaries. When a node may receive a prompt produced by another model 42, the orchestrator 40 may sanitize and tag that prompt before forwarding. Settings may be assigned per node by reading defaults from a registry and overriding fields such as sampling temperature, nucleus probability, maximum tokens, stop sequences, or schema constraints according to plan hints or evaluator feedback.

In some embodiments, the orchestrator 40 may operate in synchronous or asynchronous modes. In synchronous mode, the orchestrator 40 may execute the call graph inline, awaiting each dependency before advancing. In asynchronous mode, the orchestrator 40 may submit independent nodes concurrently, may await completion events, and may resume dependent nodes as their inputs may become available. The orchestrator 40 may record a timeline of submissions and completions, may propagate cancellation if a branch may become irrelevant, and may checkpoint the call graph so that long-running workflows may resume after transient failures.

In some embodiments, planning may be performed once at the start or iteratively. A one-shot plan may be constructed from the initial request and executed as written. An iterative plan may be updated after each major step: the orchestrator 40 may solicit a new plan from the reasoning component by providing a compact summary of the current state, including successes, failures, and evaluator scores; the reasoning component may propose additional steps, altered branches, or revised prompts; and the orchestrator 40 may apply the update to the running call graph. This arrangement may allow branching based on responses, repeated refinement cycles, or backtracking when an approach may not meet checks, while keeping the flow grounded in explicit calls to the artificial intelligence models 42.

In some embodiments, the orchestrator 40 may expose administrative controls to register models 42, attach adapters, define plan templates, and configure evaluators and thresholds. The orchestrator 40 may log prompts, settings, responses, and decisions with identifiers so that replay or audit may be performed, and may export summarized traces to downstream systems. The orchestrator 40 may support staged deployments in which only a fraction of traffic may exercise new plans or model 42 versions, with the remainder using prior configurations, and may switch traffic based on observed evaluator scores.

In some embodiments, an orchestrator 40 may perform retrieval-augmented generation by constructing context to pair with prompts submitted to artificial intelligence models 42. The orchestrator 40 may parse an incoming request, extract queryable terms or entities, and issue retrieval calls to one or more backends such as vector indexes, structured databases, key-value stores, or web connectors. For vector retrieval, the orchestrator 40 may compute or request an embedding for the request, search a vector database for nearest neighbors under a configured similarity rule, and fetch the corresponding passages together with metadata such as source identifiers and timestamps. For structured retrieval, the orchestrator 40 may prepare parameterized SQL statements that may target tables designated for facts, events, or configurations, and may execute the statements with bound parameters to obtain rows that may be normalized into text spans or key-value fragments. The orchestrator 40 may merge results across sources by de-duplicating near-identical passages, ranking candidates using a learned or heuristic ranker, and assembling a context window that may satisfy token budgets and policy filters prior to pairing the context with a system prompt and content prompt.

In some embodiments, the orchestrator 40 may call an artificial intelligence model 42 to assist with retrieval by generating or refining queries. The orchestrator 40 may submit a step that asks the model 42 to produce search strings, embeddings, or structured queries given the user objective and available schema hints. For example, the model 42 may emit a vector-query description, a set of Boolean search clauses, or a parameterized SQL statement. The orchestrator 40 may validate and sanitize the proposed query, may execute it against the configured backend, and may return retrieved snippets to the model 42 for summarization or citation selection. The orchestrator 40 may iterate this loop by asking the model 42 to propose follow-up queries for uncovered aspects, may expand abbreviations or entity aliases, and may re-rank retrieved items based on the model's extracted signals such as answerability or freshness labels.

In some embodiments, the orchestrator 40 may construct the final context pack by chunking documents to configured sizes, adding canonical citations, and applying filters that may remove low-confidence or stale items. The orchestrator 40 may enforce per-source quotas so that no single repository dominates the context, may insert guardrail headers that may list provenance and usage instructions, and may compress or summarize overlong passages using a model 42 prior to assembly. The resulting context pack may be concatenated ahead of or after a system prompt and content prompt and may be sent with decoding settings to a selected model 42. The orchestrator 40 may cache embeddings, intermediate search results, and assembled context packs keyed by request fingerprints so that repeated or related requests may reuse retrieval results within defined lifetimes, and may align the context layout to maximize shared prefixes across related prompts where reuse of a key-value cache on the target model 42 may be supported.

In some embodiments, the one or more artificial intelligence models 42 may be hosted locally, including fine-tuned variants deployed within an enterprise environment. In other embodiments, the models may be remote, third-party hosted, general-purpose foundation models accessed over a network through service endpoints. Hybrid arrangements may be used in which certain stages run on local fine-tuned models while other stages call external foundation models.

FIG. 2 is a flow chart of a process 50 that may be executed by some embodiments of the controller 20 or by other components to automatically create a custom software application. In some embodiments, the process 50 includes obtaining an objective for a multi-agent artificial intelligence platform to generate a software application, as indicated by block 52. Some embodiments may obtain an objective by receiving a natural-language request, a structured form, or an API call that states what application a user wants and why, then determining context such as user role, tenant, domain indicators, data sensitivity, timelines, and device constraints. The system 12 may access prior missions and relevant documents, normalize the objective into a machine-parsable record with fields for goals, inputs, outputs, success criteria, and review points, and resolve ambiguous terms using definitions from enterprise sources. The platform 14 may validate scope against policy, attach provenance for who requested what and when, and create a mission record with identifiers and versioning so later steps can trace changes. In some cases, the intake path may also obtain preferences, personas, compliance requirements, and target environments, and cause an initial session to be created so downstream agents can decompose tasks, select user interface components, and begin generation under the captured constraints.

Some embodiments may determine a domain to which the objective applies, as indicated by block 54. Some embodiments may determine a domain to which the objective applies by obtaining the mission text, attached files, and contextual signals and then analyzing them for domain indicators. The system may access language models and classifiers to detect terminology, entity types, units, regulatory citations, document templates, and source-system identifiers that correlate with domains such as finance, healthcare, manufacturing, or research. The platform may query a knowledge graph to resolve defined terms and product names, determine relationships to prior missions, and compute similarity to known domain exemplars. The controller 20 may combine these signals into a confidence score per domain, apply tenant policies that restrict eligible domains, and select one or more domains when the score exceeds a threshold. When ambiguity persists, the platform may request a short clarification, rank alternatives, and record the chosen domain with provenance to the inputs that supported the decision.

In some cases, the system 12 may determine that the objective spans multiple domains and cause a composite assignment. The platform 14 may partition tasks by domain, select domain specific agents 28 accordingly, and bind outputs so later steps can evaluate cross-domain constraints. The determination may adapt over time as additional documents arrive or as users supply feedback, and the controller 20 may update the domain assignment and trigger re-planning when new evidence shifts confidence. The process may preserve privacy by redacting sensitive fields during analysis and may enforce tenant rules so domain detection only accesses sources and models authorized for the requesting user.

Some embodiments may access information in the domain, as indicated by block 56. Some embodiments may access information in the domain by obtaining documents, datasets, and service endpoints associated with the selected domain and tenant, then determining which sources to query based on policy, relevance, and data locality. The system 12 may connect to the enterprise data repository 15 to retrieve records from databases, knowledge bases, wikis, document stores, and object archives, and may call internal or external APIs that expose domain feeds and reference tables. The system 12 may apply authentication, authorization, and redaction before transfer; normalize encodings and units; and extract text, tables, and images for downstream analysis. Metadata such as source identifiers, schema versions, effective dates, and ownership may be recorded so later steps can trace lineage and enforce retention and residency rules. Where private networks are used, the platform may route requests through private endpoints or peering links and may perform computation near the data to reduce movement of sensitive content.

In some cases, the system 12 may index or cache retrieved material under a domain-scoped namespace, determine embeddings or other retrieval features, and attach provenance to page ranges and diagram coordinates so later views can present citations. The system 12 may resolve cross-references among documents, map defined terms to canonical entities, and reconcile overlapping sources using precedence and confidence scores. When streaming or time-series inputs are present, the system 12 may subscribe to updates and maintain snapshots aligned to evaluation timestamps.

Some embodiments may use the information in the domain with a reasoning AI model to decompose the objective into sub-objectives to complete the objective, as indicated by block 58. Some embodiments may obtain a mission and apply a reasoning model that plans, tests, and revises a path from objective to working features. The model may access domain material, align the mission to known entities and processes, and determine candidate steps that move the objective forward while honoring policy and resource limits. The model may form a task graph with dependencies and acceptance conditions, name the data each step requires, and predict the artifacts each step must produce, such as structured records, rules, or views. The controller 20 may request several alternative breakdowns, and the model may score them for feasibility, clarity of evidence, and expected latency, and select a version that balances coverage with simplicity.

Some embodiments may combine different forms of reasoning to improve reliability. A planner may outline high-level phases, a solver may fill in concrete inputs and outputs, and a checker may verify that each step can be satisfied with available data and agents. The model may run short simulations with representative samples from the enterprise data repository 15 to estimate whether a step will succeed, then modify the plan when a data field is missing or a constraint would be violated. The model may generate rubrics for subjective checks and predicates for objective checks so later evaluation can mix deterministic rules with language-guided scoring while keeping provenance to source passages and diagram regions.

Some embodiments may constrain generation with explicit limits that reduce error and drift. The model may bind variables to schemas known to domain specific agents 28 and task specific agents 30, restrict tool calls to whitelisted capabilities, and require that every produced field carry a citation or an origin. When multiple interpretations exist, the model may fork candidates, rank them using retrieval over prior missions and patterns, and discard branches that fail quick consistency tests, such as whether a proposed rule references a defined term or whether a planned view can render within size limits. The model may also compute counter-examples that would break a step and then adjust the step so the counter-examples no longer apply.

Some embodiments may use self-review to raise confidence before handing a plan to the controller 20. A first pass may draft sub-objectives and interfaces, a second pass may critique missing validations, unsafe data flows, or unclear outputs, and a third pass may rewrite steps with explicit acceptance conditions. The model may express each sub-objective as a contract that names inputs, expected outputs, error cases, and fallback variants so the UI planner 24 and the orchestrator can call agents predictably. During runtime the same reasoning loop may operate at a smaller scale: when feedback indicates a gap, the model may localize the affected step, propose a minimal change, and produce a patch that the UI generator 26 can apply in place while the runtime 32 preserves state.

Some embodiments may use language models to interpret an objective, align terms to domain entities, and draft candidate decompositions. The models may obtain examples from prior missions and the enterprise data repository 15, determine tasks, inputs, and outputs, and express a first-pass plan with acceptance conditions and citations. Constrained decoding and tool-grounding may keep outputs within known schemas so each sub-objective names agents, data contracts, and views that downstream components can execute. When ambiguities appear, the models may generate alternatives, score them against retrieved precedents, and select a version that satisfies policy, latency, and evidence requirements.

Some embodiments may apply reinforcement learning to improve the decomposition policy over time. The system may define rewards based on task success, coverage of requirements, user satisfaction signals, test pass rates, latency budgets, and audit completeness. A planner policy may choose among decomposition actions such as splitting a task, merging steps, swapping an agent, or changing evaluation order, while a bandit or contextual bandit may select agent variants or prompts given domain and data features. Offline logs may supply trajectories for off-policy training, and online updates may refine the policy when unit tests, contract checks, and human feedback indicate better choices. Safety constraints may limit exploration to whitelisted tools and schemas, and shaped rewards may encourage plans that carry provenance and minimize sensitive data movement.

Other models may contribute structure and verification. A symbolic or SAT/ILP (Boolean Satisfiability/Integer Linear Programming) solver may check dependency and resource constraints, a graph neural network may refine precedence and data flow on the task graph, and probabilistic calibration may attach confidence to each sub-objective so low-confidence steps trigger review or alternative branches. Program synthesis models may generate validators and transformation code that implement acceptance conditions, while retrieval models may surface templates for common workflows such as compliance compare or topology analyze.

Some embodiments determined with the AI platform 14, user interface components of the software application as indicated by block 60. Some embodiments may determine user interface components by obtaining the mission record, domain assignment, and constraints, then causing the AI platform 14 to propose views and widgets that satisfy the stated tasks. The platform 14 may interpret required inputs and outputs, select components such as file uploaders, text inputs, tables, charts, galleries, graph visualizations, compare panes, and result panels, and determine bindings that connect each component to agent outputs and repository fields. The platform 14 may also determine interaction logic by naming events, handler signatures, validation rules, and provenance slots so results appear with citations and so subjective checks include rubric text and scoring placeholders.

Some embodiments may evaluate alternatives under device, accessibility, and policy constraints and may choose responsive variants that adapt to screen size and density. The platform 14 may assign stable identifiers, determine event sequencing for loading and error recovery, and specify content negotiation rules so components resize, collapse, or switch representations when space or data changes. Where the objective spans multiple domains, the platform may insert domain-specific views (such as compliance rule browsers, diagram callouts, or topology panels) and determine the data contracts and agent calls required to keep them current. The result may be a component plan that the UI generator can translate into executable code without manual wiring.

Some embodiments orchestrate a plurality of AI agents of the AI platform to determine how to configure at least some of the UI components and how to respond from input from at least some of the UI components, as indicated by block 62. Some embodiments may orchestrate a plurality of agents on the AI platform 14 to determine configuration for user interface components and to generate responses to user input. The controller 20 may obtain the component plan from the UI planner 24 and cause agent calls that supply each component's data contract, validators, and interaction rules. Domain specific agents 28 may return sector-aware schemas, rule expressions, and example payloads, while task specific agents 30 may produce extractors, selectors, summarizers, and formatters. The orchestrator 40 may assign call order, fan out requests where parallelism is possible, and join results into a single payload per component that the UI generator 26 can bind. For components that require subjective scoring or explanation, the orchestrator may obtain rubric text and prompt templates and attach them to the handler specification so the runtime 32 can call a language model when the user submits input.

During operation, the orchestrator 40 may receive events from the runtime 32 that reflect user actions such as upload, select, filter, compare, and annotate, and may determine which agents to invoke and which caches to read before returning an updated view model. For streaming or long-running work, the orchestrator may cause partial results to arrive incrementally and may signal state transitions for loading, success, and error. When an agent becomes unavailable or returns low-confidence output, the orchestrator may select a fallback variant, request a secondary check, or downgrade a component to a reduced representation while preserving provenance. The orchestrator may also enforce policy by redacting fields before display, by routing sensitive calls through private endpoints, and by recording per-call parameters, model versions, and citations so each response can be traced to its sources.

In some cases, the orchestrator 40 may adjust configuration in response to feedback and context. If filters produce sparse results, the orchestrator may obtain relaxed predicates and propose an alternate component such as a list in place of a dense table. If a compliance view receives a new policy document, the orchestrator may re-run rule extraction and update bindings so highlights and links remain aligned with source coordinates. Where multiple agents can satisfy the same role, the orchestrator may select among them using latency, cost, and accuracy signals and may propagate the choice back to the controller 20 for later regeneration, allowing the application to evolve without manual rewiring while keeping input handling and component behavior consistent with the plan.

Some embodiments may generate code for event handlers by obtaining the component plan and emitting functions that receive events, validate inputs, call agents or repositories, and update view state. The generator may determine handler signatures, expected payloads, and error cases and produce code that debounces rapid inputs, retries on transient faults, and records provenance for displayed results. Handlers may include guards that check permissions and redaction rules before rendering sensitive fields and may attach citations or coordinates to any output so a user can trace where a value came from. For long-running actions, the code may cause optimistic updates, stream partial results, and transition components through loading, success, and error states according to a state machine defined in the plan.

Some embodiments may generate content negotiation code that adapts components to different screen sizes and client resources. The generator may determine breakpoints and minimum readable sizes and emit responsive logic so dense tables become cards on small screens, wide graphs switch to list or overview-plus-detail modes, and media downscales when bandwidth or memory is limited. The code may detect device class, pixel density, and input method and adjust touch targets, focus order, keyboard paths, and motion preferences to meet accessibility guidelines. Layout code may compute grid placements and flex rules, reserve space for localization, and preserve stable identifiers so when a layout changes during a session, focus, scroll position, and selected items remain consistent.

Some embodiments may emit security-focused code paths that reduce the risk of prompt injection, SQL injection, cross-site scripting, and related attacks. For language-model prompts, the generator may produce wrappers that separate instructions from user content, strip or neutralize model-control phrases in user input, label untrusted strings, and include signed, minimal context rather than raw page text. For data access, the generator may cause all joins and filters to use prepared statements or parameterized queries and may validate types and ranges against schemas before any call reaches a datastore or agent. For rendering, the code may escape or sanitize untrusted content by default, restrict HTML insertion to vetted templates, and isolate risky widgets in sandboxes with strict content security policies. The generator may also add origin checks for cross-site requests, same-site cookie settings, and CSRF (cross-site request forgery) tokens for state-changing operations, and may ensure secrets remain server-side while the client receives only scoped, short-lived tokens.

Some embodiments may include compile-time and runtime checks that enforce these protections. The build may fail when a handler tries to interpolate untrusted strings into queries or templates, and the runtime may block unsafe operations and log structured errors with minimal payloads. The generator may instrument audit hooks so any result shown to a user links to the exact agent call or query that produced it, including parameters and model versions, and may include test fixtures that simulate adversarial inputs to confirm that prompt wrappers, sanitizers, and parameterization hold under stress.

Some embodiments may store a version of a generated application in memory by writing build artifacts and manifests under a unique identifier with timestamps, provenance, and policy metadata. The system may persist code bundles, templates, schemas, model and agent versions, configuration, and test fixtures, along with a registry entry that maps the identifier to routes, permissions, and data contracts. Storage may include both volatile caches for rapid rollout and durable stores for audit and rollback, with integrity checks, signatures, and hashes to verify contents at load time. In environments with residency or classification rules, the platform may assign storage locations by tenant and domain and may encrypt artifacts at rest with keys controlled by the enterprise.

During operation, the controller 20 may cause the runtime 32 to load a stored version, hydrate it with session state, and apply patches that represent deltas from prior versions. The platform may maintain immutability of prior versions while recording lineage between versions so operators can revert or compare. Snapshots may capture dependent resources such as prompts, rubric text, and data-contract schemas to ensure reproducibility, and deduplication may reduce storage when large assets repeat across versions. When a new version is created, the system 12 may stage it alongside the active version, run contract and unit tests, and then substitute it for users with state preservation where compatible, while keeping the retired version available for investigation or rollback.

Some embodiments determine whether feedback has been received, as indicated by block 66. If feedback is received, program flow may return to block 62, otherwise it may proceed to block 68, in response. Some embodiments may determine whether feedback has been received by obtaining signals from multiple channels and evaluating them against recorded expectations for the active mission and version. The platform may receive natural-language comments, thumbs-up or thumbs-down selections, in-line annotations, and uploaded examples from within the application and from the dashboard generator 36, and may collect automated results such as unit tests, contract checks, accessibility probes, and performance budgets. The feedback module 34 may normalize inputs, identify the affected view, component, rule, or data contract, and record provenance that links each signal to user identity, session, page region, or test case. The controller 20 may cause periodic or event-driven scans of these stores, determine whether any new or unresolved items exist, and update a status that indicates whether feedback is present for the application, for a specific version, or for an element within that version.

Some embodiments may apply thresholds and policies to decide if captured signals qualify as actionable feedback. The system 12 may aggregate duplicates, merge near-matches, and assign severity and confidence based on source, frequency, and test reliability. Time windows may bound consideration to recent sessions or post-release intervals, and tenant rules may limit who can trigger regeneration. When the system 12 determines that feedback has been received, it may notify the controller 20 with a summary that names targets and suggested actions. When no qualifying signals appear, system 12 may record a check with timestamp for audit and continue monitoring. Privacy and security controls may ensure that only authorized reviewers can access the underlying comments or artifacts, with redaction applied to sensitive fields before any analysis or display.

Some embodiments may execute the version of the software application as indicated by block 68. Some embodiments may execute a stored version by causing the runtime 32 to load its code bundles, configuration, and schemas, initialize routes and permissions, and hydrate state for the active session. The runtime 32 may obtain credentials for the requesting user, determine tenant and policy context, and establish connections to authorized sources in the enterprise data repository 15 and to eligible agents on the AI platform 14. View definitions and state machines may drive rendering and interactions, with handlers validating inputs, calling agents, applying redaction, and attaching provenance so displayed results link to the underlying queries or model calls. Caches and data stores may warm as the session progresses, while accessibility and content negotiation rules adapt layouts to the client's screen and input method.

During execution, the platform may monitor latency, errors, and resource use, apply backoff and retries on transient faults, and select fallbacks when an agent or source is unavailable. When the feedback module 34 or controller 20 provides a patch or a regenerated plan, the runtime 32 may apply the update in place, substitute the new components or bindings, and carry forward compatible state such as selections, filters, focus, and scroll positions. Multi-tenant controls may isolate configuration and data per tenant, and private networking may route calls over restricted links. Audit trails may record which version produced each output with model and schema identifiers, enabling rollback or comparison if needed.

Some embodiments are distinct from other approaches in a variety of aspects, which is not to suggest that those other approaches are disclaimed or disavowed. Many approaches to generating applications from natural-language prompts rely on a single pass from text to screens, often using a single model or a loosely coupled chain. These systems tend to produce brittle plans that are hard to adapt when objectives change or when domain context turns out to be incomplete. In contrast, some embodiments may decompose objectives into smaller sub-goals using a coordinated set of specialized agents, each focused on planning, retrieval, evaluation, tooling, or execution. The agents may share a structured workspace that tracks assumptions, intermediate outputs, and confidence, allowing replanning of only the portions that need it rather than regenerating everything.

Many approaches to UI creation focus on template filling and static layouts, which can struggle with different form factors and with dynamic state that emerges at runtime. Some embodiments may compile planning artifacts directly into responsive UI bundles and event handlers, with content negotiation for screen size and client capabilities. The code may include accessibility affordances and telemetry hooks by default, so the same high-level plan can be realized across web and native environments with consistent behavior and observability.

Many approaches to code generation treat security as an afterthought or rely on generic sanitizers that are inserted late in the process. Some embodiments may generate security measures alongside the UI and backend logic, including prompt-boundary wrappers, input validation, output encoding, SQL parameterization, and policy checks at tool and model boundaries. By emitting these controls as first-class code and configuration, the resulting application may resist prompt injection, cross-site scripting, and injection attacks without extensive manual hardening.

Many approaches to orchestration assume a fixed pipeline or a single model family, which can limit robustness when inputs vary or when tasks require different strengths. Some embodiments may route work across heterogeneous models and tools using adapters and evaluators that compare candidates, enforce budget or latency constraints, and carry forward provenance of what data and models influenced a decision. This arrangement may improve reproducibility and auditability because each step records its inputs, outputs, and rationale in a way that can be re-played or inspected later.

Many approaches to improvement run offline loops that require users to restart sessions or accept disruptive redeployments. Some embodiments may operate a live runtime that supports state-preserving hot patches, targeted code substitutions, and guarded rollbacks. Telemetry from usage, tests, and synthetic probes may feed a feedback module that decides when to re-plan or re-generate specific components, so updates can be small, reversible, and tied to observed issues rather than broad, risky releases.

Many approaches to knowledge ingest focus on plain text and bag-of-words extraction, which can miss structure, context, and provenance. Some embodiments may parse mixed-media documents into machine-readable objects with explicit links back to page ranges and coordinates, and may separate objective facts from subjective clauses while retaining both. For engineering drawings and schematics, some embodiments may detect symbols and connections, perform vectorization, and assemble a topology graph that captures how components relate. Local legends and references may condition detection, and the system may export connection tables and bills of materials with confidence scores and citations to source regions.

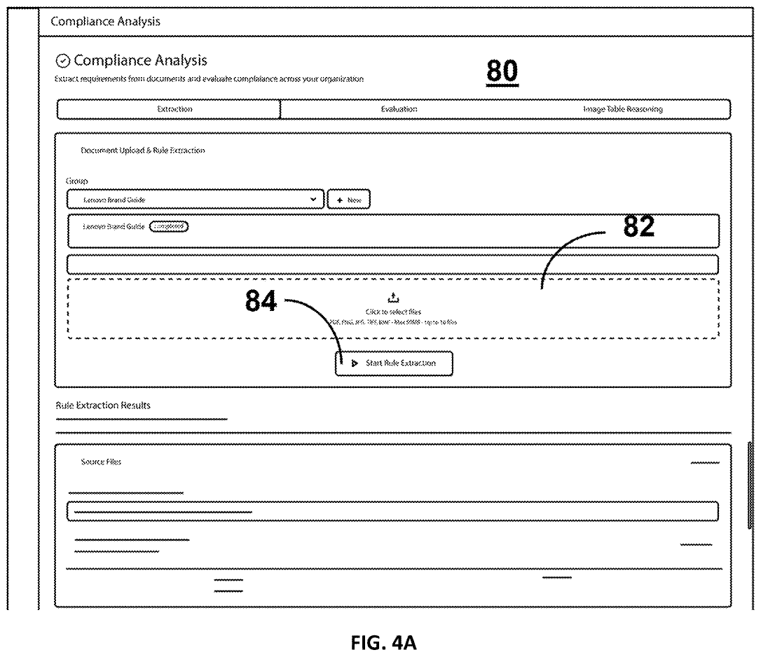

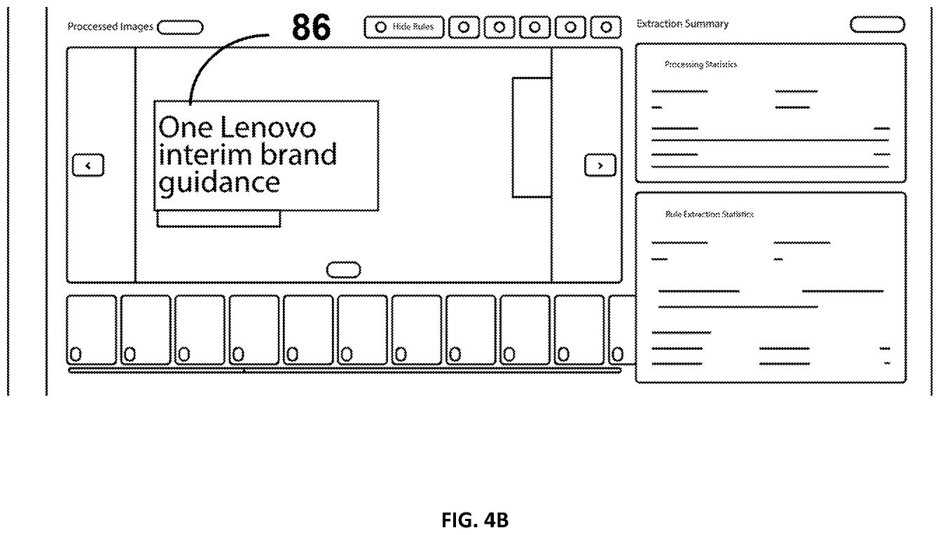

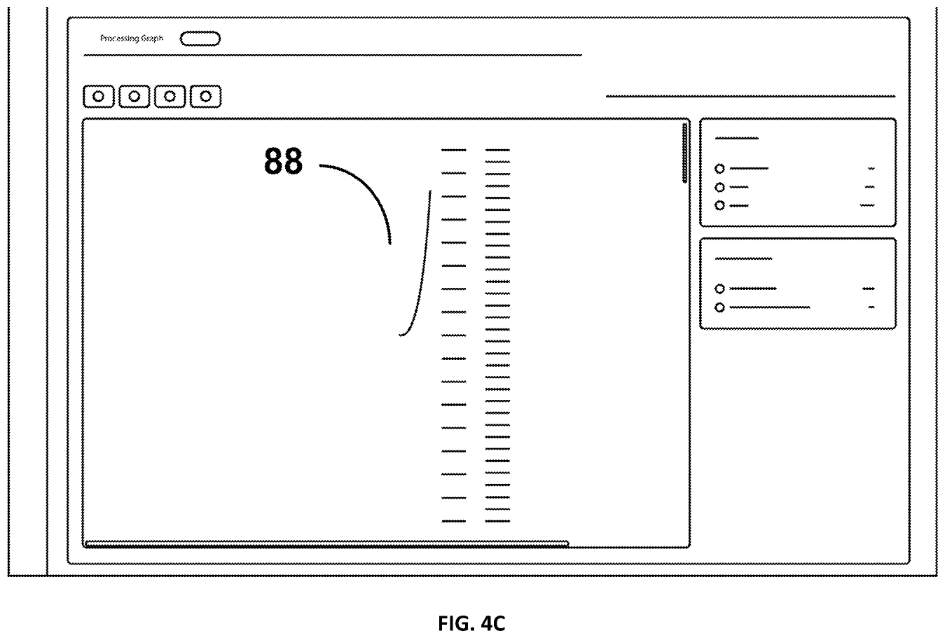

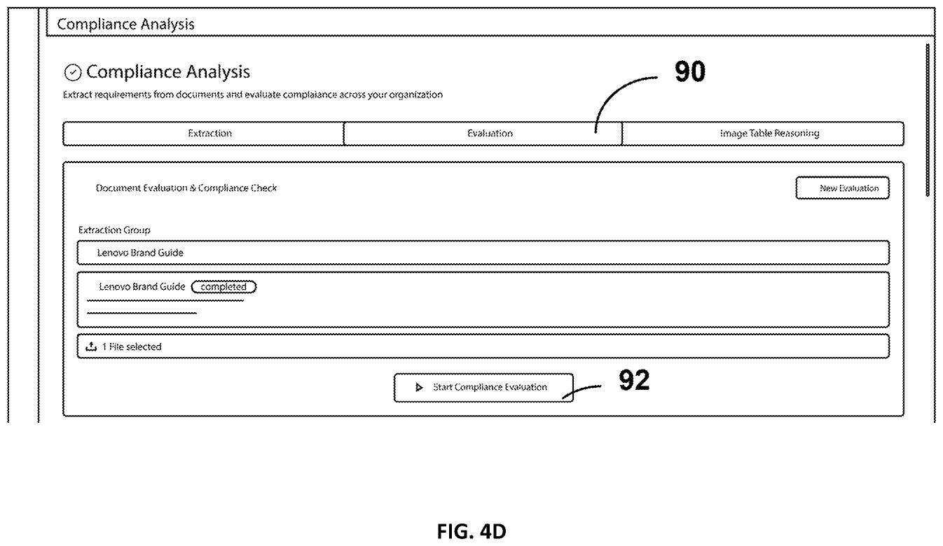

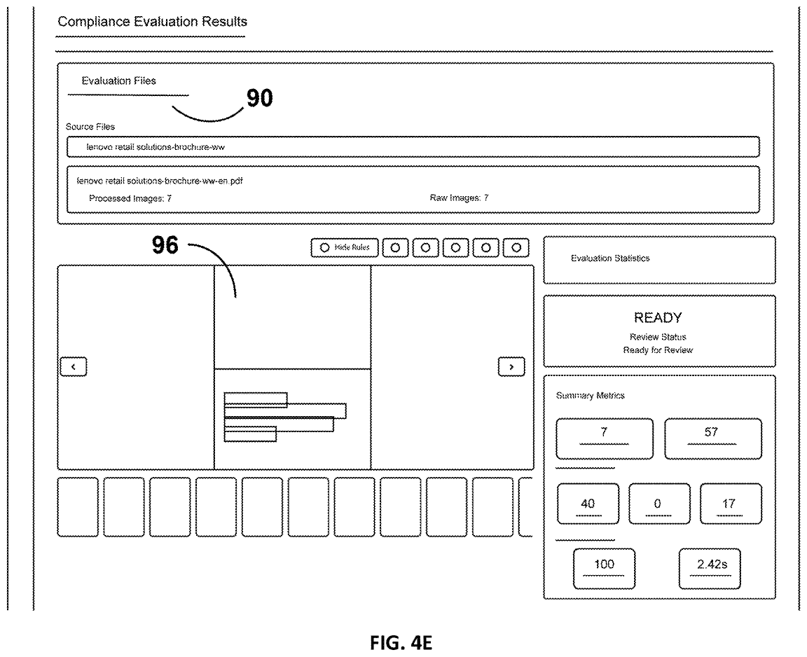

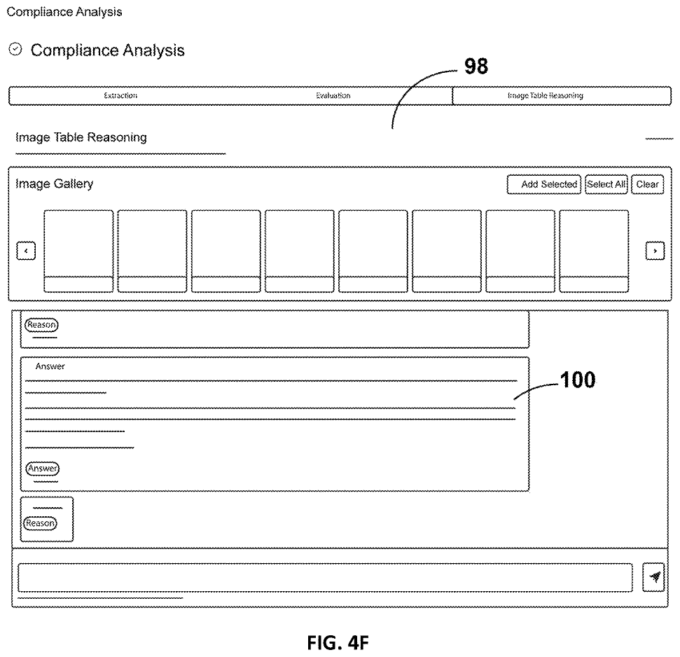

FIG. 4A through 4F show user interfaces of an example software application created with the techniques described above. A user interface may evolve while still being the same UI. These figures are segments of the user interface in two different states, with FIGS. 4A through 4C showing one state in which requirements are extracted and FIGS. 4D through 4F showing another state in which requirements are applied. The bottom of FIG. 4A corresponds to the top of FIG. 4B and so on through the UI figures as indicated.

This example may ingest a natural language document or otherwise unstructured document describing rules or other requirements to which an organization or user is expected to adhere. Extract those requirements and then apply them to other documents. The user interface 80 may include a file ingest component 82 by which documents expressing requirements may be uploaded upon selecting an upload button 84, which is another user interface component. The application may be configured to process images and display those images as indicated in region 86 of the user interface. This component may display different images that are processed. Some embodiments may display a graphical representation 88 in another user interface component with a hierarchical visualization of the document processing pipeline showing relationships between documents, pages, and extracted rules.

Mode selector user interface component 90 may include an option to select an evaluation mode in which new documents may be uploaded as evaluation files through user interface component 94, and the user may request to start compliance evaluation with user interface element 92. Examples may be presented in component 96 showing the application of requirements to various images and other aspects in this example.

FIG. 4F shows another mode of the software application with an image table reasoning feature in component 98 for exploring compliance analysis, and a chat component 100 for asking answering questions with one or more of the AI models 42 described above.

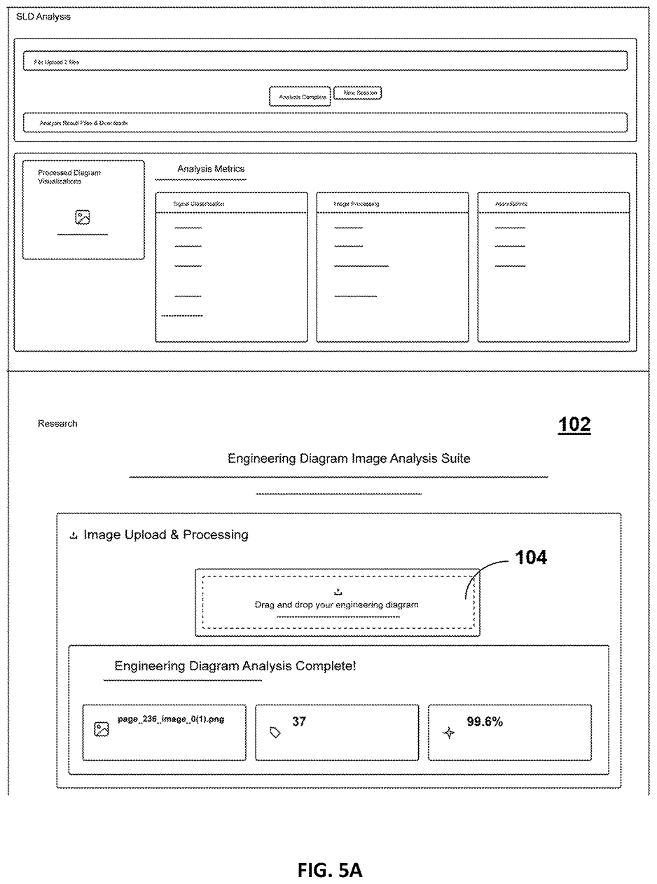

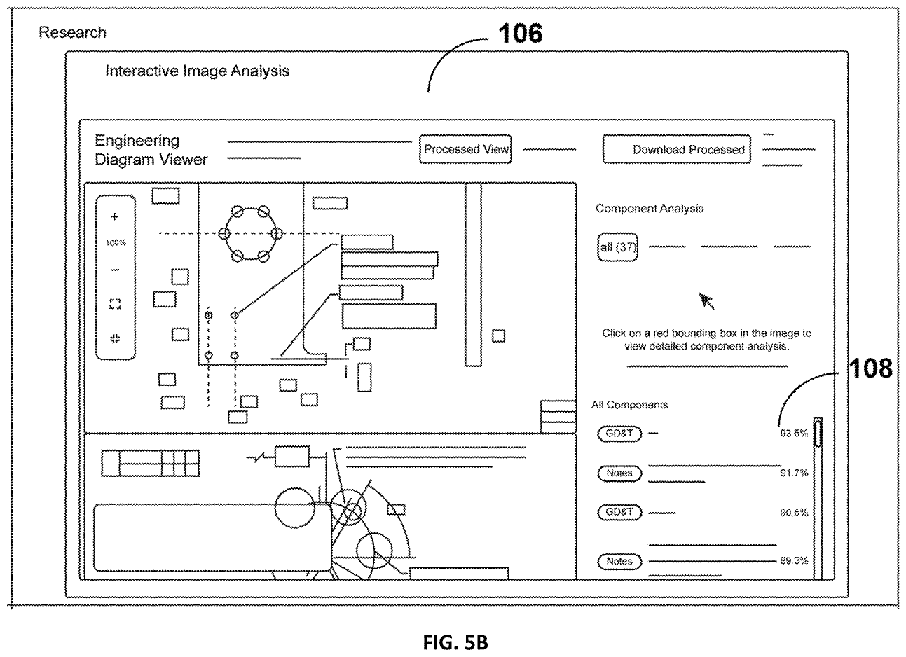

FIGS. 5A and 5B illustrate user interfaces 102 of another example generated software application. This example may be for analyzing technical documents, such as technical diagrams. Some embodiments may provide a user interface component 104 by which engineering diagrams may be uploaded. Some embodiments may analyze diagrams in those images and annotate them as indicated in user interface component 106 and generate an inventory of components therein as indicated in user interface component 108.

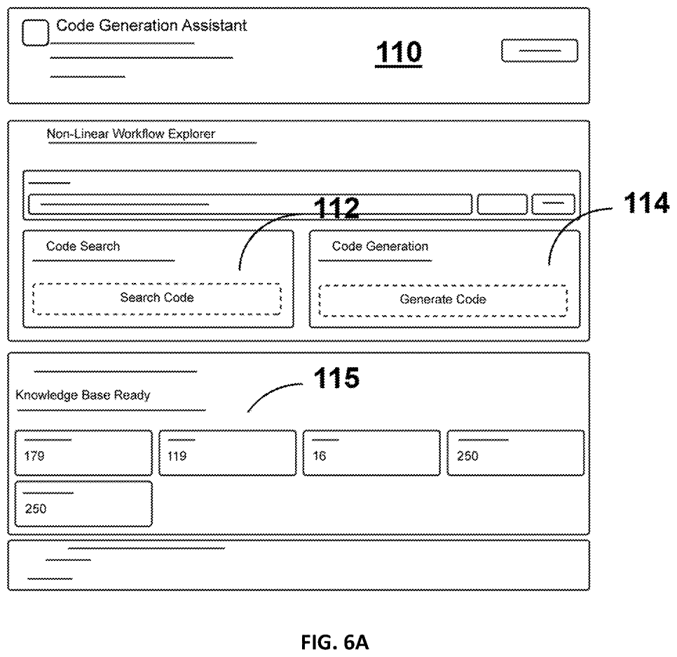

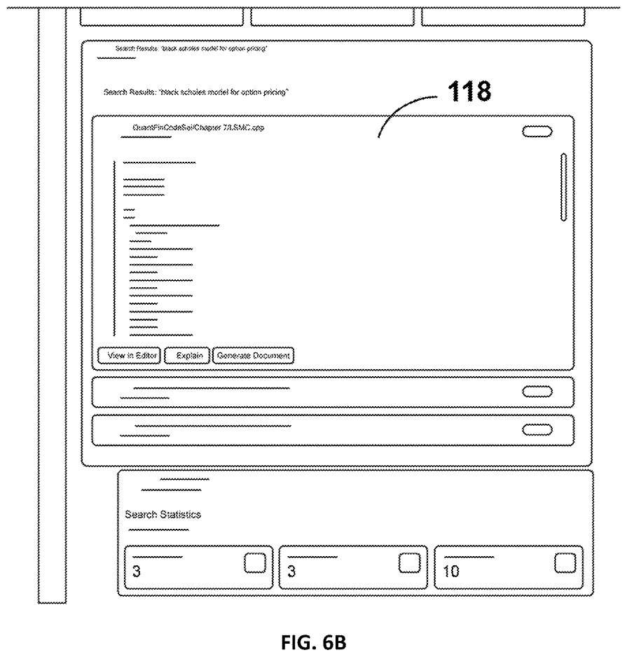

FIGS. 6A and 6B illustrate another example of a generated software application, User Interface 110, for a code generation assistant. Some embodiments include a code search user interface component and a generate code user interface component 112 and 114 respectively. Embodiments may further include statistics on a knowledge base in component 116 generated upon analyzing a code base. Embodiments may have a user interface component 118 showing results of code search.

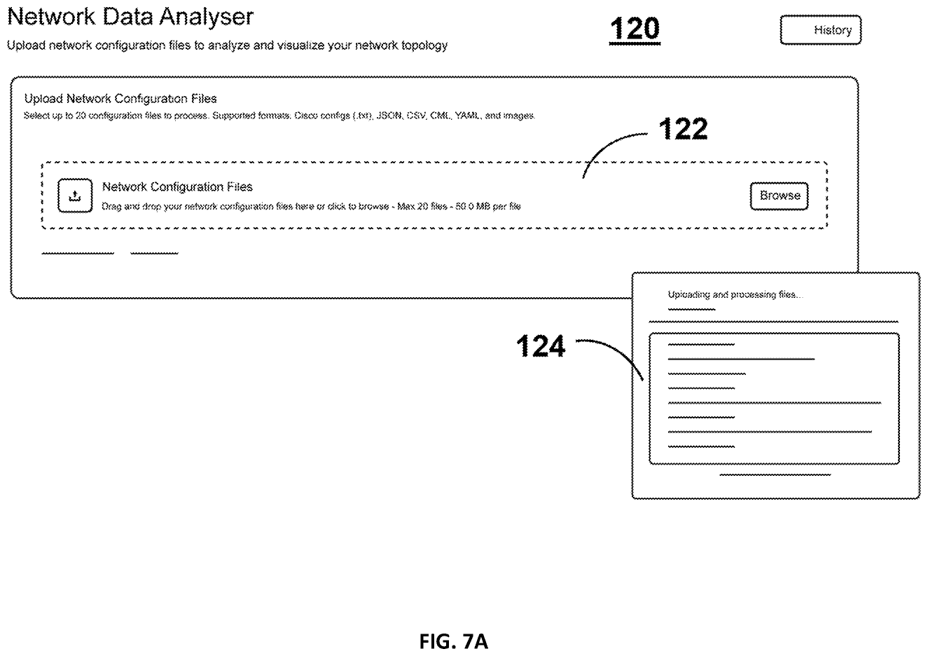

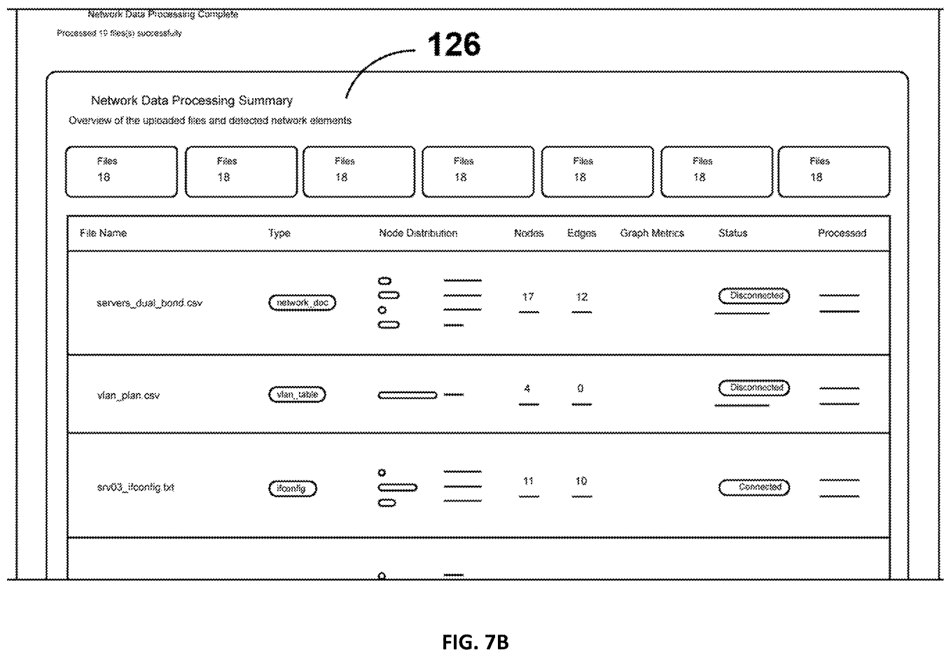

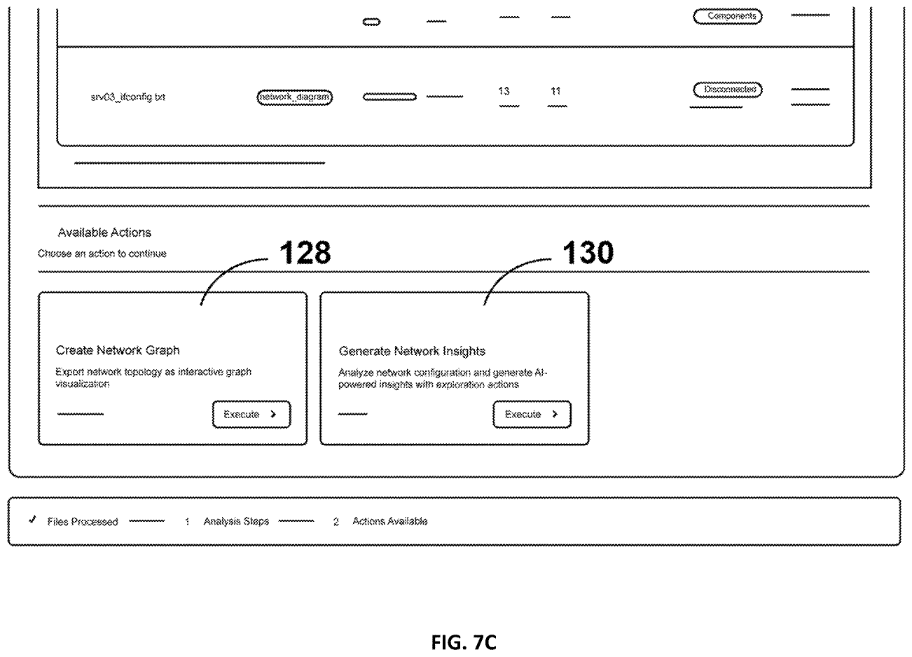

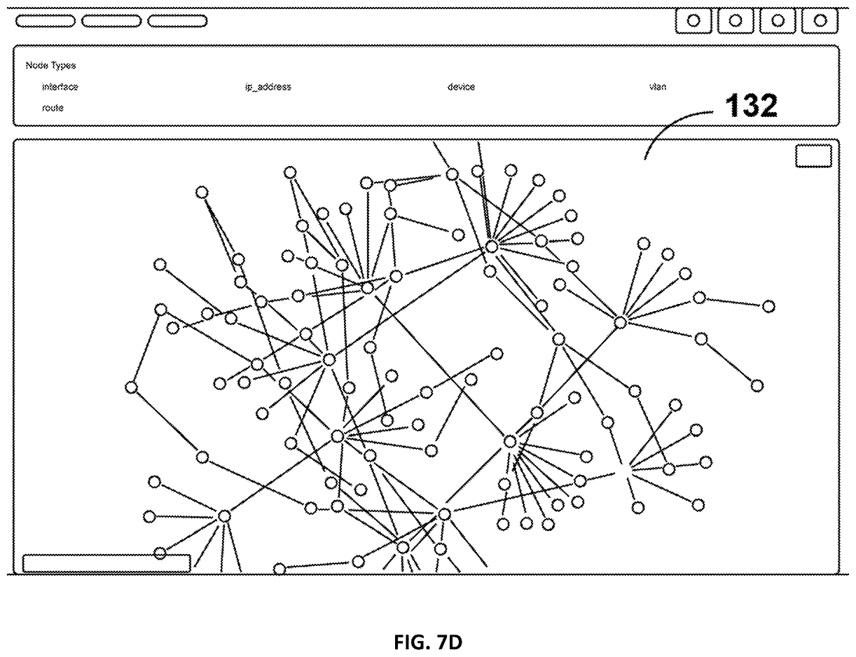

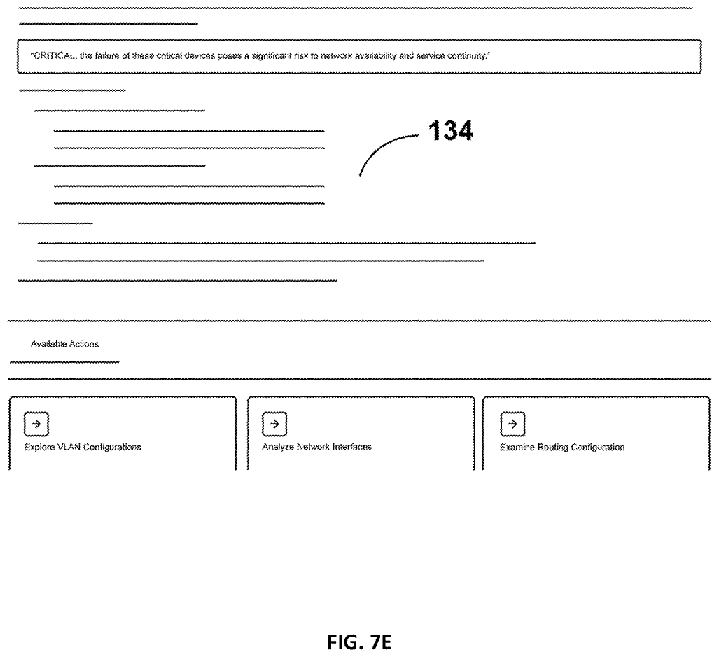

FIG. 7A through 7E may show a user interface 120 of a network data analyzer generated application. The application may include a user interface component 122 to upload network configuration files and a status indicator component 124 indicating status of uploading and processing files. Components may include a data processing summary component 126 with a network data processing summary should be emphasized that components may include components themselves in a hierarchy such as those illustrated. Embodiments may include further interfaces and components 128 and 130 for creating a network graph and generating network insights respectively. FIG. 7D shows an example of a network graph in a UI component 132 illustrated by selecting component 128. FIG. 7E shows an example of a user interface component with recommended actions which may be generated with one of the above described AI models 42.

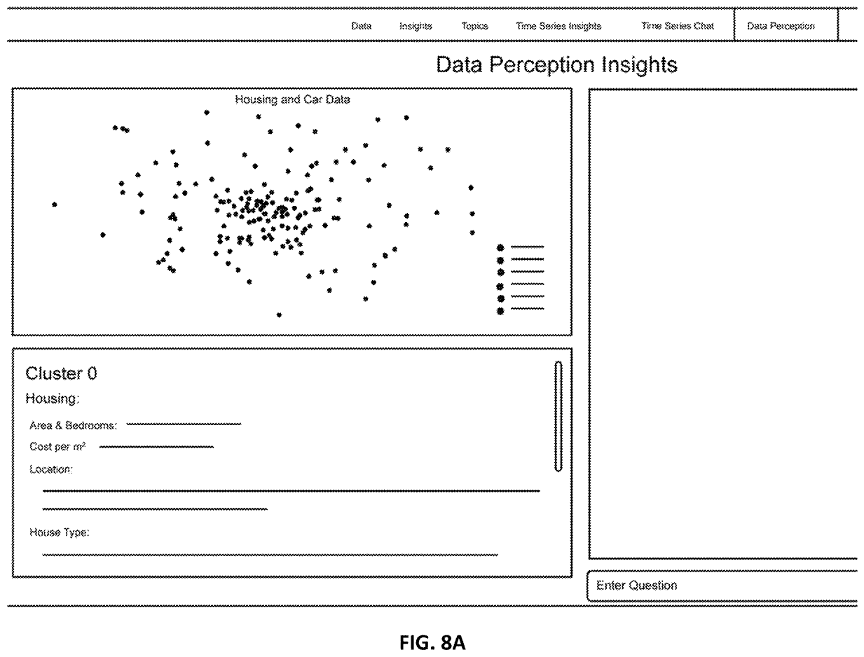

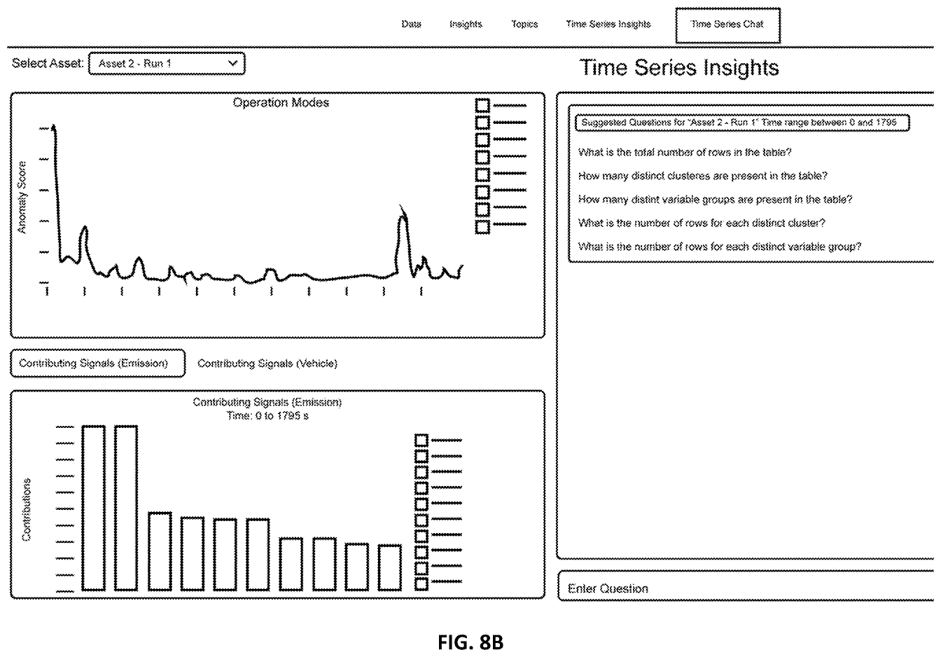

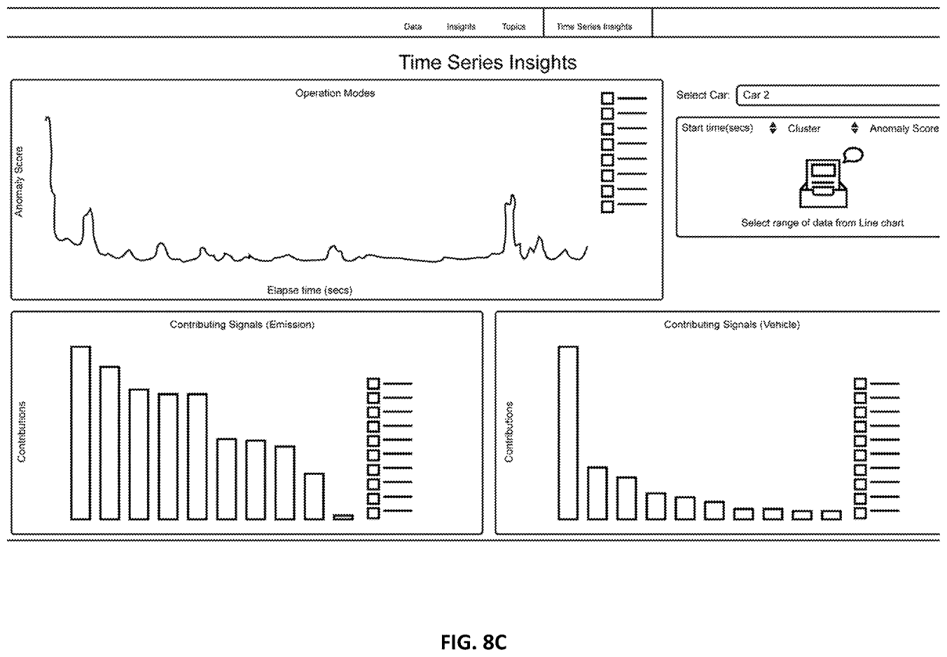

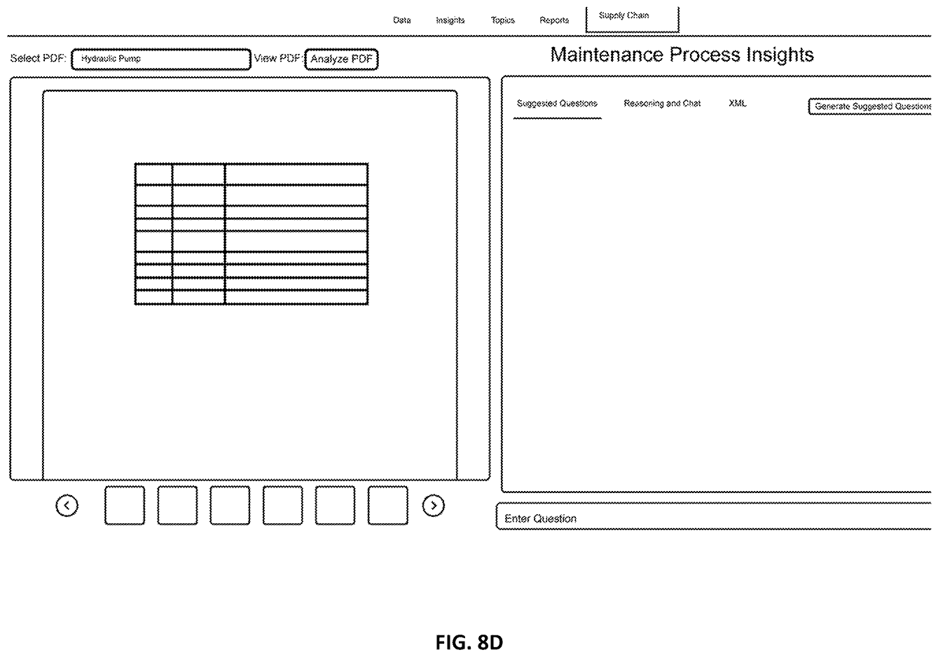

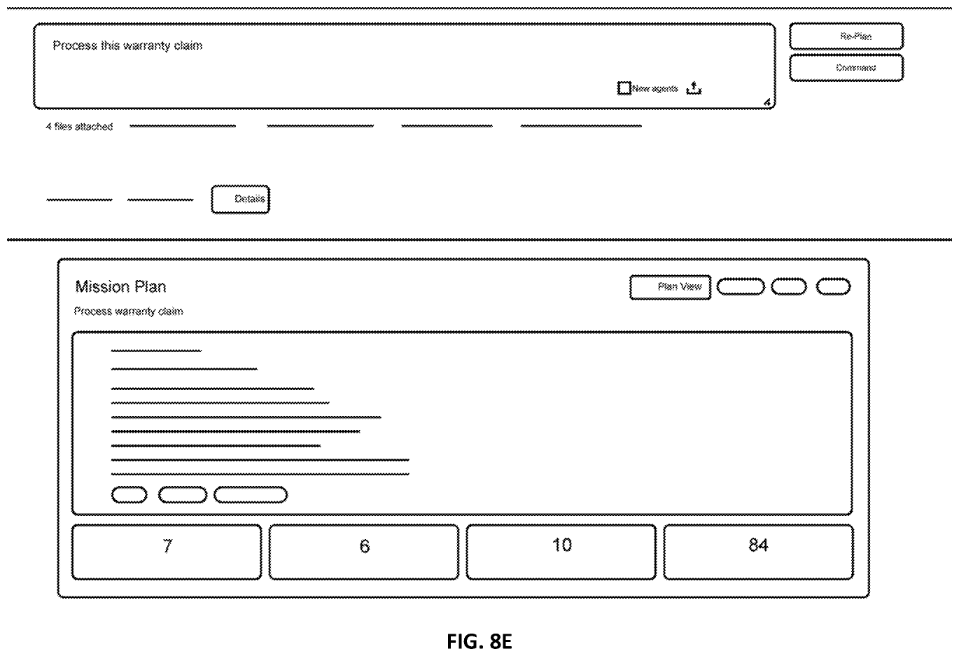

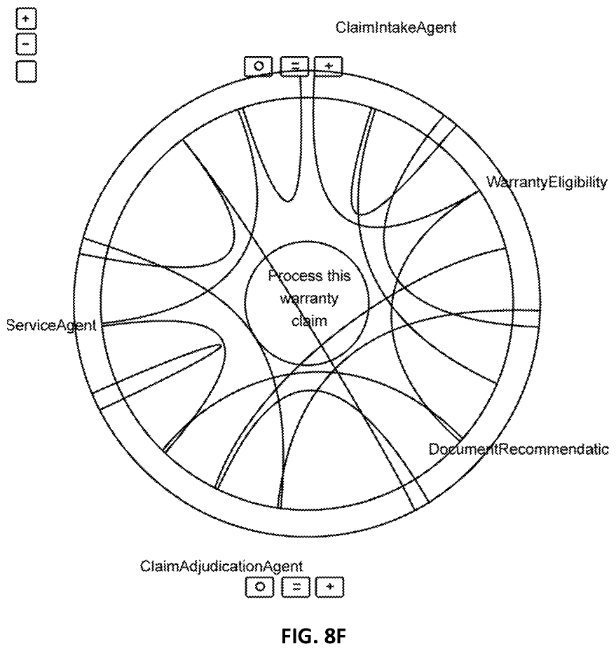

FIGS. 8A through 8F show example user interface components for a generated data analysis application. FIG. 8A shows data perception insights. FIG. 8B shows time series insights. FIG. 8C shows further time series insights. And FIG. 8D shows maintenance processing insights. FIG. 8E shows a user interface to process a warranty claim with a preview of steps to be performed by the application when doing so. And FIG. 8F shows a chord diagram for the processing of warranty claims in this example generated software application.

FIG. 9 shows an example of a dashboard showing usage and status of various generated software applications.

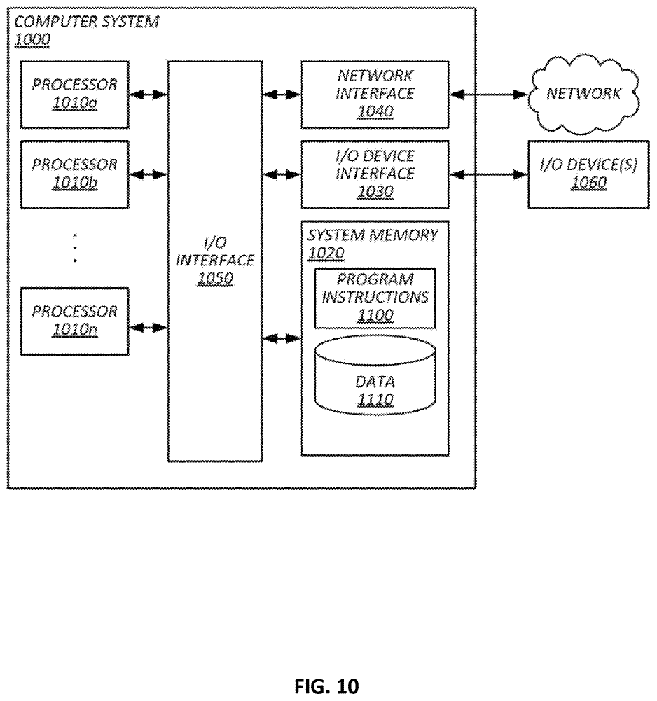

FIG. 10 is a diagram that illustrates an exemplary computing system 1000 in accordance with embodiments of the present technique. A single computing device is shown, but some embodiments of a computer system may include multiple computing devices that communicate over a network, for instance in the course of collectively executing various parts of a distributed application. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:

Embodiment 1. A tangible, non-transitory, machine-readable medium storing instructions that, when executed, effectuate operations comprising: obtaining, with a computer system, an objective for a multi-agent artificial intelligence (AI) platform to generate a software application; determining, with the computer system, a domain to which the objective applies; accessing, with the computer system, information in the domain; using, with the computer system, the information in the domain, with a reasoning AI model, decomposing the objective into sub-objectives to complete the objective; determining, with the computer system, with the AI platform, user interface (UI) components of the software application; orchestrating, with the computer system, a plurality of AI agents of the AI platform to determine how to configure at least some of the UI components and how to respond to input from at least some of the UI components; and storing, with the computer system, a first version of the software application in memory.

Embodiment 2. The medium of embodiment 1, the operations comprising: determining a spatial layout of at least some of the UI components with the AI platform.

Embodiment 3. The medium of embodiment 2, wherein determining the spatial layout comprises generating content negotiation code by which UI components are sized or positioned based on screen dimensions of a client computing device.

Embodiment 4. The medium of embodiment 1, wherein at least some of the sub-objectives comprise: uploading a document from which rules applied by the software application are extracted; applying the rules to an evaluation document to form evaluation results; and causing the extracted rules and evaluation results to be presented to a user providing the objective.

Embodiment 5. The medium of embodiment 1, wherein determining at least some of the UI components comprises generating code of respective event handlers responsive to interaction with the respective UI components.

Embodiment 6. The medium of embodiment 1, wherein the AI platform comprises more than one thousand AI agents responsive to an orchestrator.

Embodiment 7. The medium of embodiment 6, wherein at least some of the AI agents are specific to the domain and are selected by the orchestrator in response to the orchestrator determining those AI agents are specific to the domain.

Embodiment 8. The medium of embodiment 6, wherein at least some of the AI agents are specific to respective tasks.

Embodiment 9. The medium of embodiment 1, comprising: receiving feedback from a user who provided the objective on the first version of the software application; and in response to the feedback, changing at least some of the UI components to generate a second version of the software application.

Embodiment 10. The medium of embodiment 9, wherein the feedback is obtained during a use session with the first version of the software application and the second version of the software application is substituted for the user during the session with session state matching that of the first version of the software application at the time of the substitution.

Embodiment 11. The medium of embodiment 1, wherein: the information in the domain is accessed in a private enterprise network; and the software application is deployed in the private enterprise network.

Embodiment 12. The medium of embodiment 1, wherein: the AI platform comprises more than 100 AI agents and at least some of the more than 100 AI agents are task specific AI agents and at least some of the more than 100 AI agents are domain specific AI agents.

Embodiment 13. The medium of embodiment 1, wherein: determining the UI components of the software application is performed with a UI planner AI agent of the AI platform; and at least some of the UI components comprise: a clustered graph; a time series graph; a force-directed graph; or a chord diagram.

Embodiment 14. The medium of embodiment 1, wherein determining the UI components of the software application comprises: interpreting at least some of the sub-objectives, decomposing tasks, and selecting UI components and layout with a first AI agent of the AI platform; and generating executable code by which at least some of the UI components are rendered and updating the executable code with a second AI agent of the AI platform.

Embodiment 15. The medium of embodiment 1, wherein the software application is configured to: ingest a document expressing compliance requirements in natural language text and images; extract the requirements based on both the natural language text and the images; cause a visualization of a processing pipeline of the document to be displayed, the visualization showing relationships between documents, pages, and extracted rules.

Embodiment 16. The medium of embodiment 15, wherein the software application is configured to: ingest another document and evaluate compliance of the other document with the extracted requirements; and present, with at least some of the UI components, a visual association between content of the other document and determinations of compliance or non-compliance.

Embodiment 17. The medium of embodiment 1, wherein the software application is configured to: ingest, via at least some of the UI components, an engineering design document; detect and analyze an engineering diagram in the design document to generate an inventory of components within the diagrams; and present, with at least some of the UI components, the inventory of components.

Embodiment 18. The medium of embodiment 1, wherein the software application is configured to: ingest a configuration file of a network; and cause, with at least some of the UI components, a visualization of a network topology to be displayed.

Embodiment 19. The medium of embodiment 1, wherein the objective comprises a natural-language or otherwise unstructured prompt that is transformed into a structured plan including a task graph with dependencies and success checks; wherein the domain comprises a scoped knowledge space having a schema and provenance for sources, and the information in the domain is retrieved under policies that cite source locations into the plan; wherein the multi-agent AI platform comprises at least two concurrently operating agents with distinct roles, message-based interaction, tool permissions, and an evaluator that adjudicates among candidate outputs; wherein the reasoning AI model produces a machine-consumable plan or call graph that specifies sub-objectives, required tools, and evaluation hooks; wherein decomposing the objective into sub-objectives yields executable tasks conditioned on the information in the domain and supporting partial re-planning; wherein determining the UI components yields a typed component tree with properties, layout constraints, accessibility attributes, and event contracts including responsive content negotiation for client capabilities; wherein orchestrating the plurality of AI agents includes exchanging messages to compare candidate configurations and emitting event-handler code or state-machine specifications bound to the typed component tree; and wherein storing the first version comprises persisting an executable, deployable bundle including generated code, a dependency manifest, configuration, embedded security controls for input validation and output encoding, telemetry instrumentation, and lineage metadata linking the bundle to the objective, the cited domain information, and the inter-agent messages.

Embodiment 20. A tangible, non-transitory, machine-readable medium storing instructions that when executed by a data processing apparatus cause the data processing apparatus to perform operations comprising: the operations of any one of embodiments 1-19.

Embodiment 21. A system, comprising: one or more processors; and memory storing instructions that when executed by the processors cause the processors to effectuate operations comprising: the operations of any one of embodiments 1-19.

What is claimed is:

1. A tangible, non-transitory, machine-readable medium storing instructions that, when executed, effectuate operations comprising:
obtaining, with a computer system, an objective for a multi-agent artificial intelligence (AI) platform to construct at least a part of a software application;
determining, with the computer system, a topic to which the objective applies;
accessing, with the computer system, information in associated with the topic;
determining. with the computer system, based on the objective and information in the topic, sub-tasks of the objective;
determining, with the computer system, with the AI platform, user interface (UI) components of the software application;
orchestrating, with the computer system, a plurality of AI agents accessible by the AI platform to determine how to configure at least some of the UI components and how to respond to input from at least some of the UI components, the orchestrating comprising:
submitting sub-requests to the AI models, each sub-request being recorded with provenance comprising identifiers of the AI models, prompts, and settings used;
receiving responses from the AI models to the sub-requests;
determining a score associated with each response from the AI models based on comparison of the responses against expected outcomes; and
in response to a score falling below a threshold, determining that a subsequent request be submitted to an alternate AI model or to the same AI model with adjusted settings; and
storing, with the computer system, a first version of the software application in memory.

2. The medium of claim 1, wherein the orchestrating further comprises:
constructing a call graph comprising nodes associated with invocations of artificial intelligence models and edges associated with data dependencies among the nodes;
associating settings with nodes of the call graph; and
recording the scores associated with each response in the call graph.

3. The medium of claim 1, the operations comprising:
determining a spatial layout of at least some of the user interface components with the AI platform, wherein determining the spatial layout comprises generating content negotiation code by which UI components are sized or positioned based on screen dimensions of a client computing device.

4. The medium of claim 1, wherein
orchestrating comprises branching a step to multiple AI models in parallel with varied prompts or settings and aggregating results using rules or an evaluator model.

5. The medium of claim 1, wherein determining at least some of the UI components comprises generating code of respective event handlers responsive to interaction with the respective UI components.

6. The medium of claim 1, wherein the AI platform comprises more than one thousand AI agents responsive to an orchestrator.

7. The medium of claim 6, wherein at least some of the AI agents are specific to the topic and are selected by the orchestrator in response to the orchestrator determining those AI agents are specific to the topic.

8. The medium of claim 1, wherein orchestrating a plurality of AI agents comprises steps for orchestrating the plurality of AI agents.

9. The medium of claim 1,
wherein determining a topic comprises steps for selecting responsive layouts and establishing bindings.

10. The medium of claim 9, wherein the feedback is obtained during a use session with the first version of the software application and the second version of the software application is substituted for the user during the session with session state matching that of the first version of the software application at the time of the substitution.

11. The medium of claim 1, wherein:
the information in the topic is accessed in a private enterprise network; and
the software application is deployed in the private enterprise network.

12. The medium of claim 1, wherein
orchestrating comprises executing the call graph in synchronous mode by awaiting each dependency before advancing or in asynchronous mode by submitting independent nodes concurrently, and checkpointing the call graph to resume after transient failures.

13. The medium of claim 1, wherein:
determining the UI components of the software application is performed with a UI planner AI agent of the AI platform; and
at least some of the UI components comprise:
a clustered graph;
a time series graph;
a force-directed graph; or
a chord diagram.

14. The medium of claim 1, wherein determining the UI components of the software application comprises:
interpreting at least some of the sub-objectives, decomposing tasks, and selecting UI components and layout with a first AI agent of the AI platform; and
generating executable code by which at least some of the UI components are rendered and updating the executable code with a second AI agent of the AI platform.

15. The medium of claim 1, wherein
orchestrating comprises composing prompts per node by filling templates with values from upstream nodes. concatenating a system prompt and a content prompt, sanitizing prompts produced by another model before forwarding, and assigning decoding settings per node based on registry defaults and overrides.

16. The medium of claim 15, wherein
orchestrating comprises constructing retrieval-augmented context by computing an embedding for a request and retrieving nearest neighbors from a vector database and by executing parameterized SQL against structured sources, merging results under token budgets and policy filters before pairing the context with a prompt.

17. The medium of claim 1, wherein
executing the software application comprises recording, for each displayed result, a provenance link to an agent call or repository read that produced the result, including parameters and version identifiers.

18. The medium of claim 1, wherein
determining the user interface components or handlers comprises generating prompt-boundary wrappers that separate instructions from user content, causing joins and filters to use prepared statements or parameterized queries with schema validation, and escaping or sanitizing untrusted content by default.

19. The medium of claim 1, wherein the objective comprises a natural-language or otherwise unstructured prompt that is transformed into a structured plan including a task graph with dependencies and success checks; wherein the topic comprises a scoped knowledge space having a schema and provenance for sources, and the information in the topic is retrieved under policies that cite source locations into the plan; wherein the multi-agent AI platform comprises at least two concurrently operating agents with distinct roles, message-based interaction, tool permissions, and an evaluator that adjudicates among candidate outputs; wherein the reasoning AI model produces a machine-consumable plan or call graph that specifies sub-objectives, required tools, and evaluation hooks; wherein decomposing the objective into sub-objectives yields executable tasks conditioned on the information in the topic and supporting partial re-planning; wherein determining the UI components yields a typed component tree with properties, layout constraints, accessibility attributes, and event contracts including responsive content negotiation for client capabilities; wherein orchestrating the plurality of AI agents includes exchanging messages to compare candidate configurations and emitting event-handler code or state-machine specifications bound to the typed component tree; and wherein storing the first version comprises persisting an executable, deployable bundle including generated code, a dependency manifest, configuration, embedded security controls for input validation and output encoding, telemetry instrumentation, and lineage metadata linking the bundle to the objective, the cited topic information, and the inter-agent messages.

20. A method, comprising:
obtaining, with a computer system, an objective for a multi-agent artificial intelligence (AI) platform to construct at least a part of a software application;
determining, with the computer system, a topic to which the objective applies;
accessing, with the computer system, information in the topic;
determining with the computer system and a reasoning AI model, based on the objective and information in the topic, sub-tasks of the objective;
determining, with the computer system, with the AI platform, user interface (UI) components of the software application;
orchestrating, with the computer system, a plurality of AI agents of accessible by the AI platform to determine how to configure at least some of the UI components and how to respond to input from at least some of the UI components, the orchestrating comprising:
submitting sub-requests to the AI models, each sub-request being recorded with provenance comprising identifiers of the AI models, prompts, and settings used;
receiving responses from the AI models to the sub-requests;
determining a score associated with each response from the AI models based on comparison of the responses against expected outcomes; and
in response to a score falling below a threshold, determining that a subsequent request be submitted to an alternate AI model or to the same AI model with adjusted settings; and
storing, with the computer system, a first version of the software application in memory.
